(19) United States
(12) Patent Application Publication
(10) Pub. No.: US 2023/0228147 A1
(43) Pub. Date: Jul. 20, 2023

(54) ACTUATOR SYSTEM FOR WINDOW SHADES

(71) Applicant: The Watt Stopper, Inc., Richardson, TX (US)

(72) Inventors: Charles Derk, JR., Park Ridge, NJ (US); Michael Campagna, Fort Lee, NJ (US); Armando Figueroa, Oceanside, CA (US); James Liu, Oceanside, CA (US)

(21) Appl. No.: 18/095,359

(22) Filed: Jan. 10, 2023

Related U.S. Application Data
(60) Provisional application No. 63/298,838, filed on Jan. 12, 2022.

(51) Int. Cl. E06B 9/78; E06B 9/42

(52) U.S. Cl. CPC E06B 9/78; E06B 9/42

(57) ABSTRACT

In various arrangements, an actuator system for window shades having shade material and a beaded chain is presented, the actuator system having a cover and an actuator mechanism with a carrier, a selector, a first ratchet member, and a second ratchet member. In various arrangements, the movement of the selector facilitates engagement of one of the first ratchet member or the second ratchet member with the beaded chain so as to facilitate raising of lowering of shade material of the window shade system.

### CROSS-REFERENCE TO RELATED APPLICATIONS

The present application claims priority to U.S. Provisional Application 63/298,838 titled ACTUATOR SYSTEM FOR WINDOW SHADES filed on Jan. 12, 2022, the entirety of which is hereby incorporated by reference herein, including any figures, tables, drawings, and other information.

### FIELD OF THE DISCLOSURE

This disclosure relates to window treatments. More specifically and without limitation, this disclosure relates to window treatments actuated by a chain, cable, cord or the like.

### OVERVIEW OF THE DISCLOSURE

Various types of window treatments have shades, blinds, draperies, or other components that may be opened, closed or otherwise adjusted using various different types of mechanisms known in the art. For example, some shade systems utilize a beaded chain to facilitate opening and closing of the shade by a user. Shade material is typically placed around a roller tube so that it can be raised or lowered between an open and closed position. The shade material is raised or lowered when a user applies a downward force to the beaded chain, which causes a clutch, connected to the roller tube, and the roller tube itself to turn. The direction of the turning of the roller tube determines whether the shade material is raised or lowered. One issue with using beaded chains to manually raise or lower window shade systems is that beaded chains are a safety hazard. Specifically, beaded chains hang down from the mounts of the window shades and can be reached by young children and animals, who may get caught in the beaded chains and can be seriously injured or worse as a result. In view of these safety hazards, countries have, or are considering, banning or restricting the use of beaded chains which are free and open for people to access. As such, beaded chains must be covered if they are to be used at all. However, when the beaded chains are covered a user cannot access the beaded chain directly to apply a downward force to raise or lower the shade material.

Therefore, for all the reasons stated above, and the reasons stated below, there is a need in the art for an improved actuator system for use with window shades and other window treatments. Thus, it is a primary objective of the disclosure to provide an actuator system for window shades that improves upon the state of the art.

Another object of the disclosure is to provide an actuator system for window shades which is safe.

Yet another object of the disclosure is to provide an actuator system for window shades which complies with the restrictions or bans, or proposed restrictions or bans, on the use of beaded chains with window shade systems.

Another object of the disclosure is to provide an actuator system for window shades which is relatively easy to install.

Yet another object of the disclosure is to provide an actuator system for window shades which is cost friendly to install.

Another object of the disclosure is to provide an actuator system for window shades which can be installed quickly and efficiently.

Yet another object of the disclosure is to provide an actuator system for window shades which is easy to install correctly.

Another object of the disclosure is to provide an actuator system for window shades which is easy to use.

Yet another object of the disclosure is to provide an actuator system for window shades which is cost friendly to manufacture.

Another object of the disclosure is to provide an actuator system for window shades which is easy to manufacture.

Yet another object of the disclosure is to provide an actuator system for window shades which is relatively lightweight.

Another object of the disclosure is to provide an actuator system for window shades which is aesthetically appealing.

Yet another object of the disclosure is to provide an actuator system for window shades which is robust.

Another object of the disclosure is to provide an actuator system for window shades which is relatively inexpensive.

Yet another object of the disclosure is to provide an actuator system for window shades which is not easily susceptible to wear and tear.

Another object of the disclosure is to provide an actuator system for window shades which has a long useful life.

Yet another object of the disclosure is to provide an actuator system for window shades which is efficient to use.

These and other objects, features, or advantages of the disclosure will become apparent from the specification, figures, and claims.

### SUMMARY OF THE DISCLOSURE

In one or more arrangements, an actuator system for window shades is presented which has a cover and an actuator mechanism and is operatively connected to a window shade system having shade material and a beaded chain. The beaded chain is positioned at least partially within the cover. The actuator mechanism has a carrier, a first ratchet member, a second ratchet member, and a selector. When a user moves the selector, the selector facilitates engagement of the first ratchet member or the second ratchet member with the beaded chain so as to facilitate raising or lowering of the shade material when the carrier of the actuator is moved relative to the cover.

### BRIEF DESCRIPTION OF THE FIGURES

FIG. 1 is a perspective view of the actuator system connected to a window shade system; the view showing the window shade system having shade material and a beaded chain; the view also showing the actuator system having a cover, and an actuator mechanism with a carrier and a selector.

FIG. 2 is another perspective view of the actuator system connected to a window shade system; the view showing the window shade system having shade material and a beaded chain; the view also showing the actuator system having a cover, and an actuator mechanism with a carrier and a selector.

FIG. 3 is a perspective view of the actuator system; the view showing the actuator system partially enclosing a beaded chain and having a cover, and an actuator mechanism having a carrier and a selector.

FIG. 4 is a front elevation view of the actuator system; the view showing the actuator system partially enclosing a beaded chain and having a cover, and an actuator mechanism having a carrier and a selector.

FIG. 5 is a side elevation view of the actuator system; the view showing the actuator system partially enclosing a beaded chain and having a cover, and an actuator mechanism having a carrier and a selector.

FIG. 6 is an exploded view of the actuator mechanism; the view showing the actuator mechanism having a front plate, intermediate plate, and rear plate; the view also showing the actuator mechanism having a selector, a first ratchet member, and a second ratchet member.

FIG. 7 is a perspective view of the actuator mechanism; the view showing the actuator mechanism partially enclosing a beaded chain and having a carrier having a front plate, an intermediate plate, and a rear plate; the view also showing the actuator mechanism having a selector with the lower end of the selector pushed inward.

FIG. 8 is another perspective view of the actuator mechanism; the view showing the actuator mechanism partially enclosing a beaded chain and having a carrier having a front plate, an intermediate plate, and a rear plate; the view also showing the actuator mechanism having a selector with the upper end of the selector pushed inward.

FIG. 9 is a front elevation view of the actuator mechanism; the view showing the actuator mechanism partially enclosing a beaded chain and having a carrier with a front plate and a selector.

FIG. 10 is a side elevation view of the actuator mechanism; the view showing the actuator mechanism partially enclosing a beaded chain and having a carrier and a selector, with the lower end of the selector pushed inward.

FIG. 11 is another side elevation view of the actuator mechanism; the view showing the actuator mechanism partially enclosing a beaded chain and having a carrier and a selector, with the upper end of the selector pushed inward.

FIG. 12 is an exploded view of a portion of the actuator mechanism; the view showing a selector with an upper end, a lower end, an engagement member, and two arms with an outer portion on each arm; the view also showing an intermediate plate and a rear plate; the view also showing a first ratchet member and a second ratchet member with each of the first ratchet member and the second ratchet member having a body, with a front surface, an outer edge, protrusions, an opening, a biasing member, and a connection end.

FIG. 13 is a perspective view of a portion of the actuator mechanism; the view showing a selector and an intermediate plate connected to a rear plate, with a portion of a beaded chain extending through the connected intermediate and rear plates; the view showing the selector with a lower end of the selector pushed inward.

FIG. 14 is another perspective view of a portion of the actuator mechanism; the view showing a selector and an intermediate plate connected to a rear plate, with a portion of a beaded chain extending through the connected intermediate and rear plates; the view showing the selector with an upper end of the selector pushed inward.

FIG. 15 is a front elevation view of a portion of the actuator mechanism; the view showing the actuator mechanism having a selector and an intermediate plate.

FIG. 16 is a side elevation view of a portion of the actuator mechanism; the view showing a selector and an intermediate plate connected to a rear plate, with a portion of a beaded chain extending through the connected intermediate and rear plates; the view showing the selector with a lower end of the selector pushed inward.

FIG. 17 is a front elevation view of a portion of the actuator mechanism; the view showing the actuator mechanism having a selector connected to a rear plate through engagement members of the selector and engagement members of the rear plate; the view also showing a first ratchet member and a second ratchet member connected to the rear plate, with the first ratchet member in a disengaged position and the second ratchet member in an engaged position.

FIG. 18 is another front elevation view of a portion of the actuator mechanism; the view showing the actuator mechanism having a selector and an intermediate plate.

FIG. 19 is another side elevation view of a portion of the actuator mechanism; the view showing a selector and an intermediate plate connected to a rear plate, with a portion of a beaded chain extending through the connected intermediate and rear plates; the view showing the selector with a upper end of the selector pushed inward.

FIG. 20 is another front elevation view of a portion of the actuator mechanism; the view showing the actuator mechanism having a selector connected to a rear plate through engagement members of the selector and engagement members of the rear plate; the view also showing a first ratchet member and a second ratchet member connected to the rear plate, with the first ratchet member in an engaged position and the second ratchet member in a disengaged position.

FIG. 21 is another exploded view of a portion of the actuator mechanism; the view showing a selector, an intermediate plate, a rear plate, a first ratchet member, and a second ratchet member.

FIG. 22 is another perspective view of a portion of the actuator mechanism; the view showing a selector and an intermediate plate connected to a rear plate, with a portion of a beaded chain extending through the connected intermediate and rear plates; the view showing the selector with a lower end of the selector pushed inward.

FIG. 23 is another perspective view of a portion of the actuator mechanism; the view showing a selector and an intermediate plate connected to a rear plate, with a portion of a beaded chain extending through the connected intermediate and rear plates; the view showing the selector with an upper end of the selector pushed inward.

FIG. 24 is another front elevation view of a portion of the actuator mechanism; the view showing the actuator mechanism having a selector and an intermediate plate.

FIG. 25 is another side elevation view of a portion of the actuator mechanism; the view showing a selector and an intermediate plate connected to a rear plate, with a portion of a beaded chain extending through the connected intermediate and rear plates; the view showing the selector with a lower end of the selector pushed inward.

FIG. 26 is another front elevation view of a portion of the actuator mechanism; the view showing the actuator mechanism having a selector connected to a rear plate through engagement members of the selector and engagement members of the rear plate; the view also showing a first ratchet member and a second ratchet member connected to the rear plate, with the first ratchet member in a disengaged position and the second ratchet member in an engaged position.

FIG. 27 is another front elevation view of a portion of the actuator mechanism; the view showing the actuator mechanism having a selector and an intermediate plate.

FIG. 28 is another side elevation view of a portion of the actuator mechanism; the view showing a selector and an intermediate plate connected to a rear plate, with a portion of a beaded chain extending through the connected intermediate and rear plates; the view showing the selector with an upper end of the selector pushed inward.

FIG. 29 is another front elevation view of a portion of the actuator mechanism; the view showing the actuator mechanism having a selector connected to a rear plate through engagement members of the selector and engagement members of the rear plate; the view also showing a first ratchet member and a second ratchet member connected to the rear plate, with the first ratchet member in an engaged position and the second ratchet member in a disengaged position.

FIG. 30 is a perspective view of a cover of the actuator system for window shades.

FIG. 31 is a top elevation view of a cover of the actuator system for window shades; the view showing the cover having a planar surface between two semi-enclosed channels.

FIG. 32 is an exploded view of an actuator system for window shades; the view showing the system having a cover and an actuator mechanism having a carrier and a selector, the view showing the actuator mechanism partially enclosing a beaded chain and the cover exploded from the beaded chain and actuator mechanism.

FIG. 33 is a rear elevation view of an actuator system for window shades; the view showing the system having a cover and an actuator mechanism having a carrier.

FIG. 34A is a perspective view of an actuator system for window shades; the view showing the system having a cover and an actuator mechanism.

FIG. 34B is a section view of the actuator system for window shades shown in FIG. 34A; the section view showing a top elevation view from near the top of the actuator system.

FIG. 35A is a front elevation view of an actuator system for window shades; the view showing the system having a cover and an actuator mechanism.

FIG. 35B is a section view of the actuator system for window shades shown in FIG. 35A; the section view showing a top elevation view from at or near the top end of the actuator mechanism.

FIG. 36A is a front elevation view of an actuator system for window shades; the view showing the system having a cover and an actuator mechanism.

FIG. 36B is a section view of the actuator system for window shades shown in FIG. 36A; the section view showing a top elevation view from at or near the middle of the actuator mechanism.

FIG. 37A is a front elevation view of an actuator system for window shades; the view showing the system having a cover and an actuator mechanism.

FIG. 37B is a section view of the actuator system for window shades shown in FIG. 37A; the section view showing a top elevation view from below the bottom end of the actuator mechanism.

FIG. 38 is a top elevation view of an alternative arrangement of an actuator system for window shades; the view showing an arrangement of the actuator system having a selector, a carrier, a cover, and a first ratchet member and a second ratchet member.

FIG. 39 is a perspective view of an alternative arrangement of a carrier; the view showing the carrier having semi-enclosed channels, a planar surface, curved slots, and lateral slots.

FIG. 40 is a front elevation view of an alternative arrangement of an actuator system for window shades; the view showing the actuator system having a selector, a carrier, a cover, a first ratchet member, and a second ratchet member.

FIG. 41 is a rear elevation view of an alternative arrangement of an actuator system for window shades; the view showing the actuator system having a selector, a carrier, a cover, a first ratchet member, and a second ratchet member; the view showing both the first ratchet member and the second ratchet member in a disengaged position.

FIG. 42 is another rear elevation view of an alternative arrangement of an actuator system for window shades; the view showing the actuator system having a selector, a carrier, a cover, a first ratchet member, and a second ratchet member; the view showing the first ratchet member in a disengaged position and the second ratchet member in an engaged position.

FIG. 43 is a front elevation view of another alternative arrangement of an actuator system for window shades; the view showing the actuator system having a selector, a carrier, a cover, a first ratchet member, a second ratchet member, and a retractable assembly.

FIG. 44 is a front elevation view of another alternative arrangement of an actuator system for window shades; the view showing the actuator system having a carrier, a cover, a first ratchet member with a first string connected thereto, a second ratchet member with a second string connected thereto, and a retractable assembly.

FIG. 45 is a front elevation view of another alternative arrangement of an actuator system for window shades; the view showing the actuator system having a cover, a carrier, and mating ramp sets with a vertical ramp and a horizontal ramp; the view also showing the horizontal ramp having a rubber layer, a portion of the interior surface semi-enclosed channels of the carrier having a rubber layer, and a beaded chain positioned between the rubber layer of the horizontal ramp and the rubber layer of the carrier.

FIG. 46A is a front elevation view of another alternative arrangement of an actuator mechanism of an actuator system for window shades; the view showing the actuator mechanism having a first ratchet member, a second ratchet member, a selector, and a carrier.

FIG. 46B is a top elevation view of the alternative arrangement of an actuator mechanism of an actuator system for window shades shown in FIG. 46A; the view showing the actuator mechanism having a first ratchet member, a second ratchet member, a selector, and a carrier.

FIG. 47A is a front elevation view of another alternative arrangement of an actuator mechanism of an actuator system for window shades; the view showing the actuator mechanism having a first ratchet member, a second ratchet member, a selector, and a carrier.

FIG. 47B is a top elevation view of the alternative arrangement of an actuator mechanism of an actuator system for window shades shown in FIG. 47A; the view showing the actuator mechanism having a first ratchet member, a second ratchet member, a selector, and a carrier.

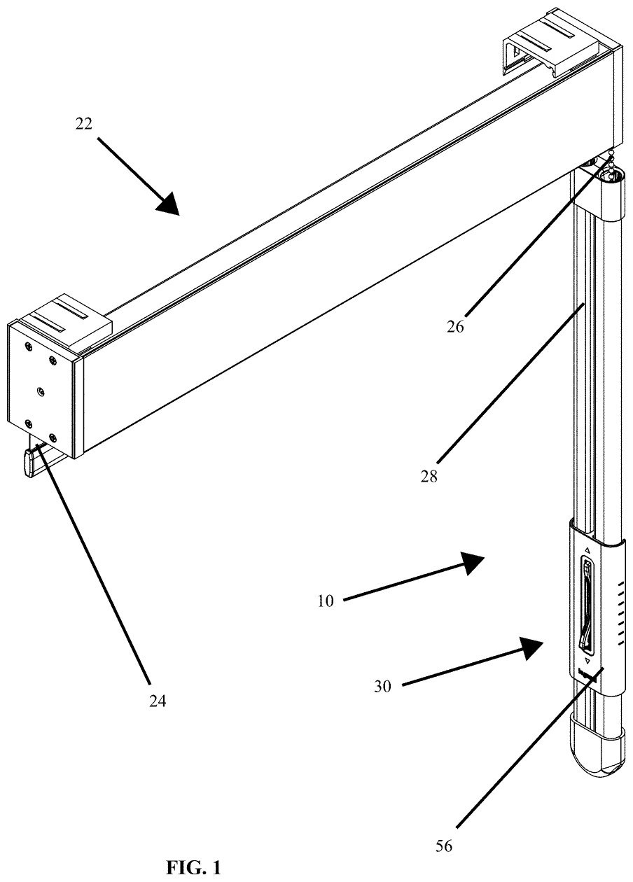

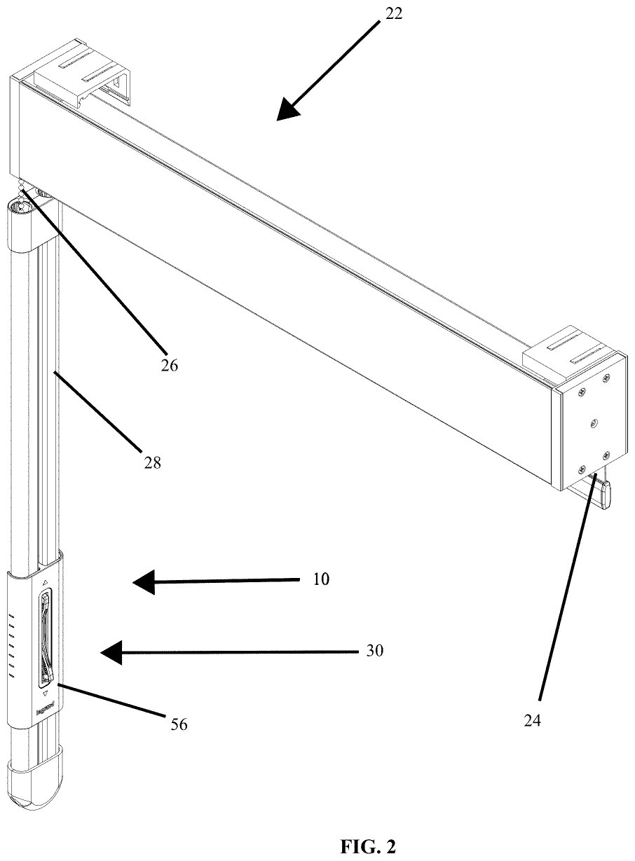

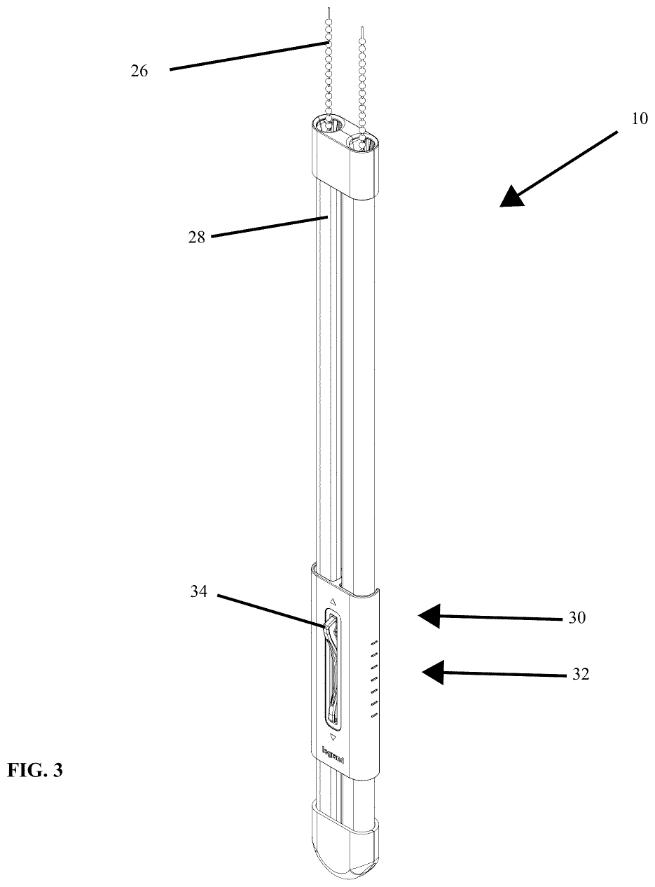

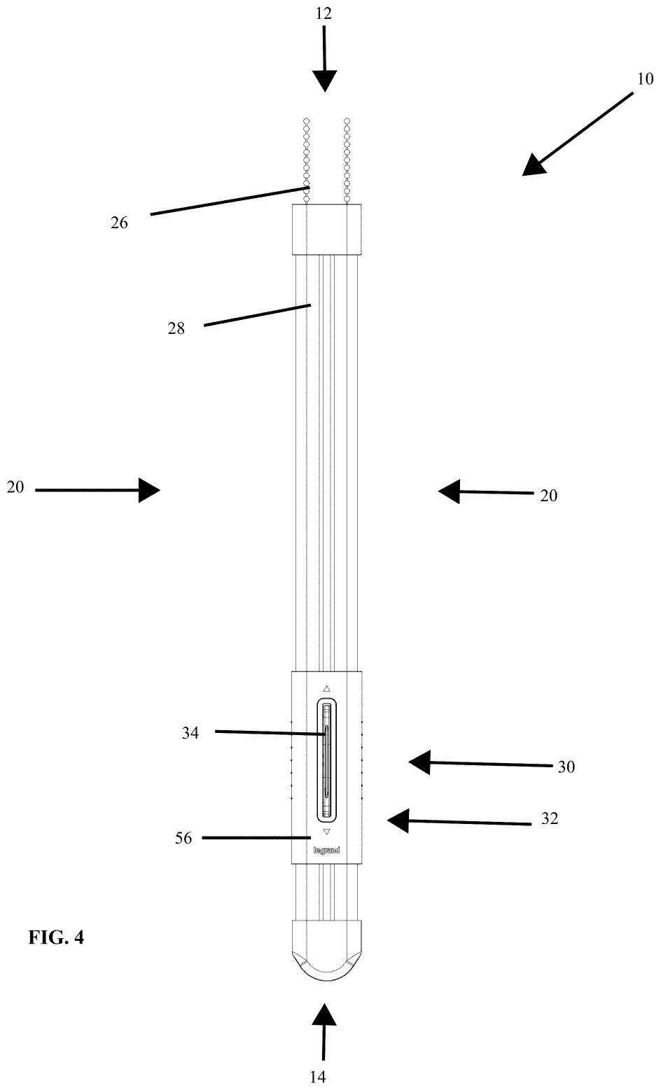

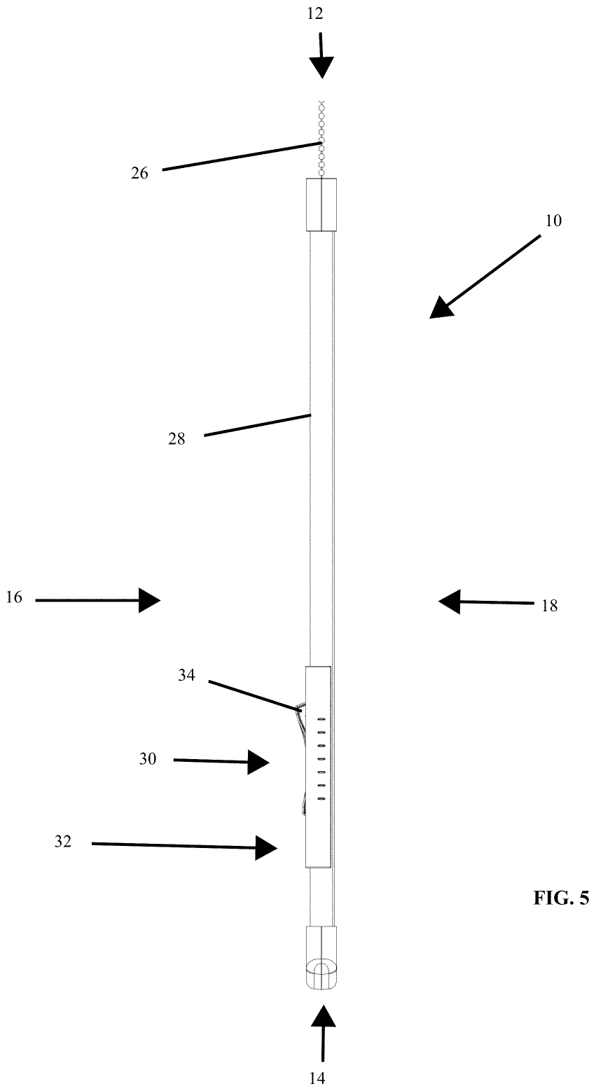

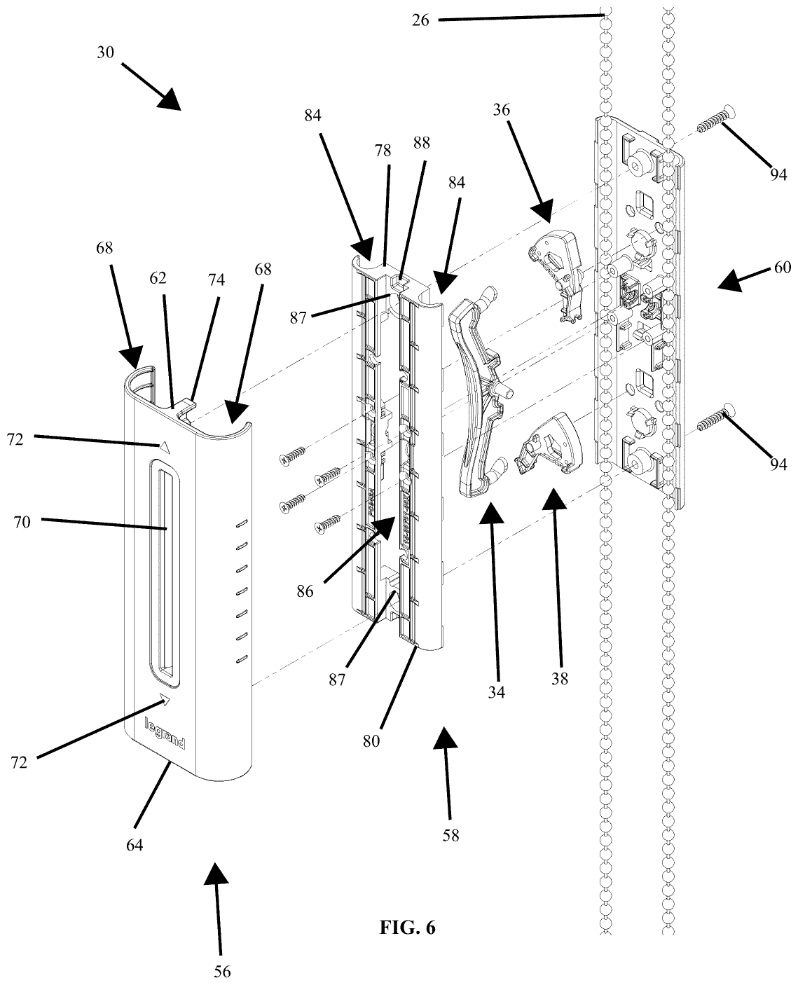

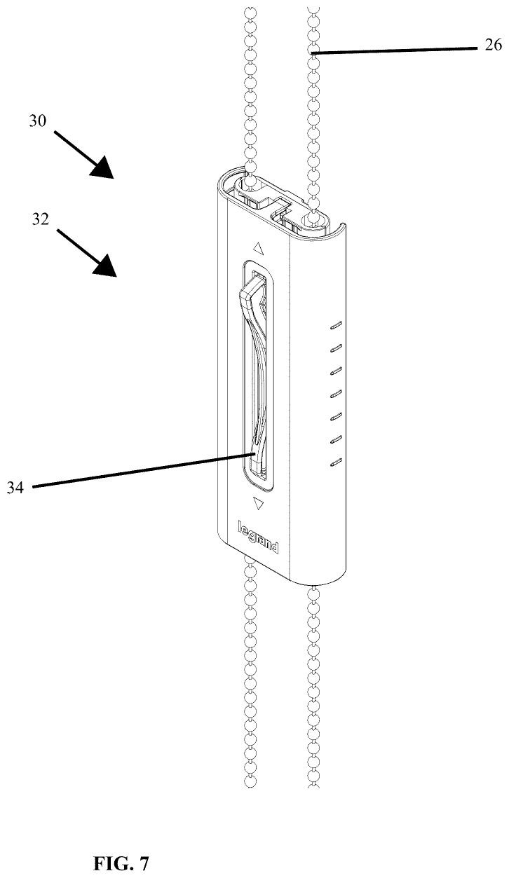

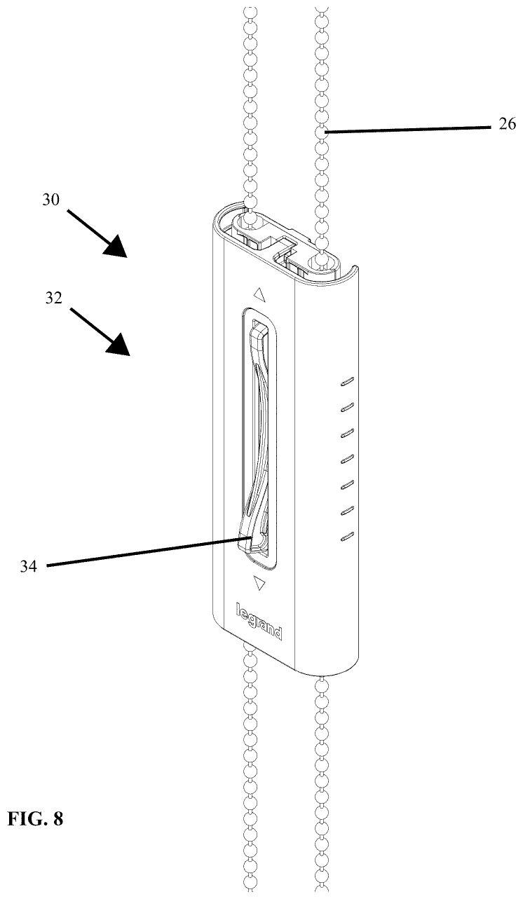

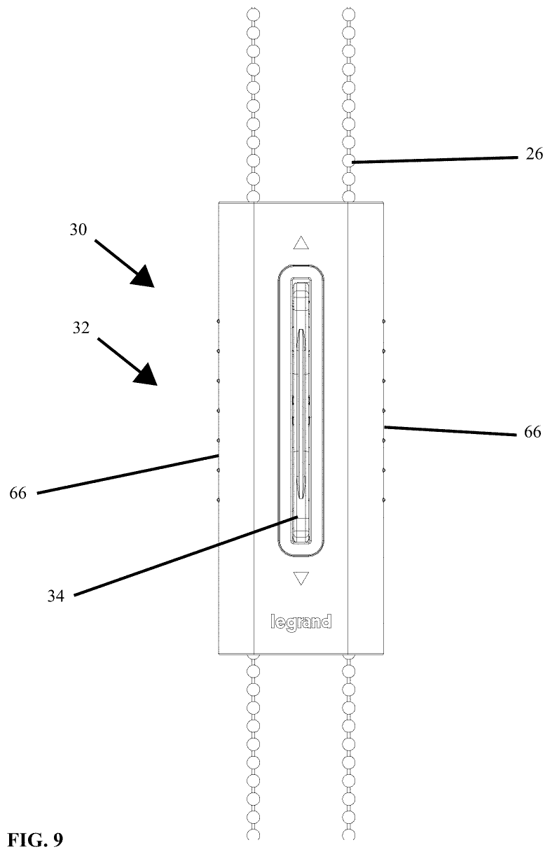

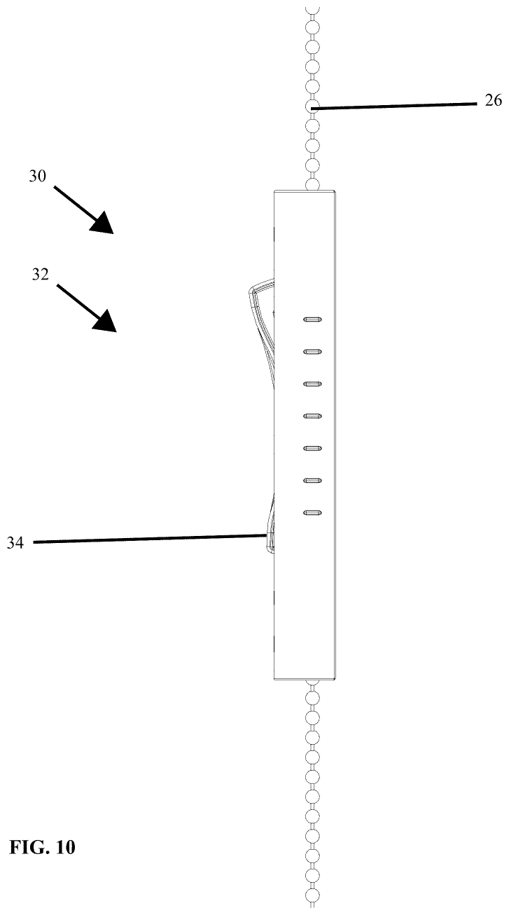

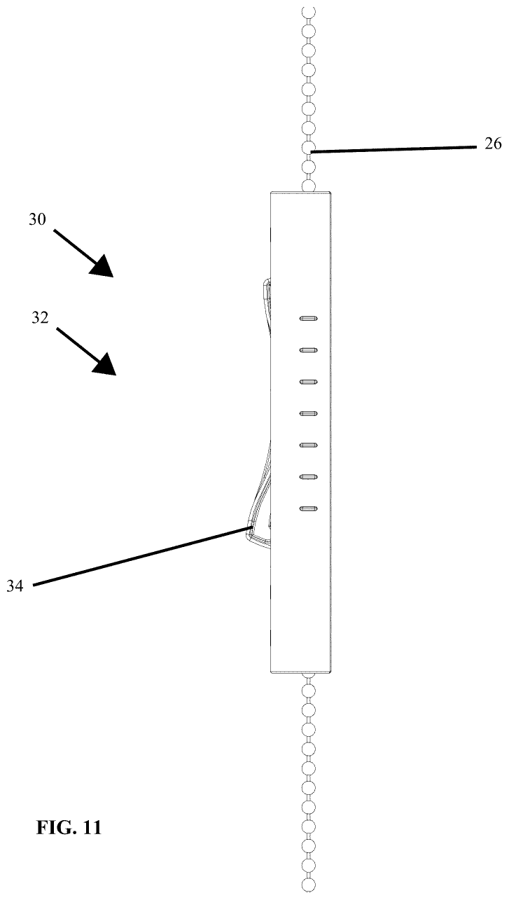

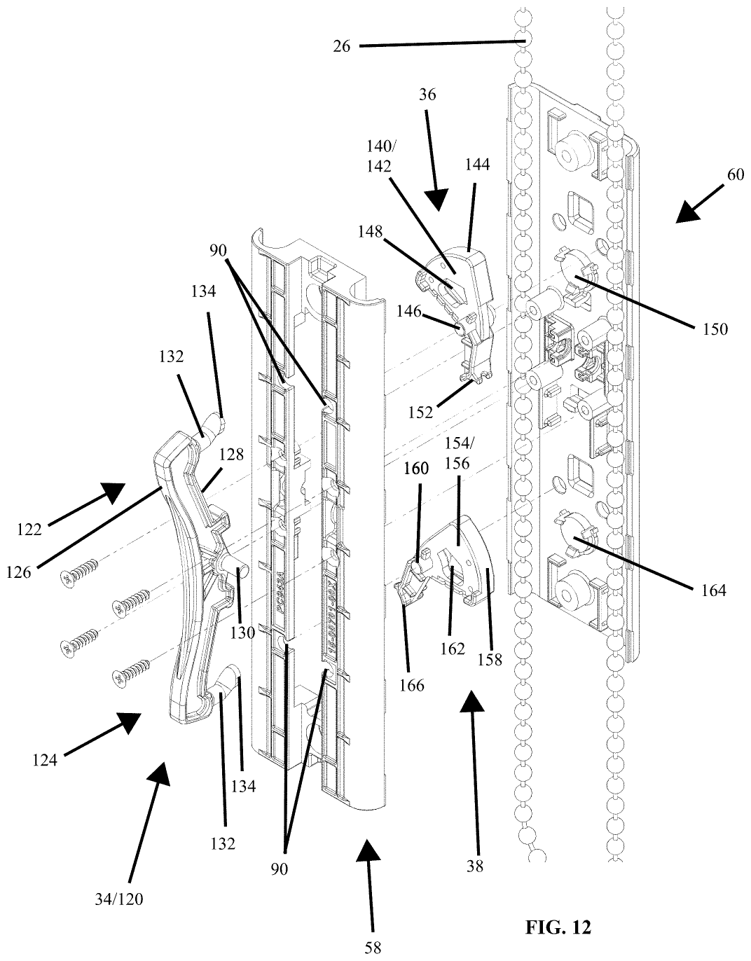

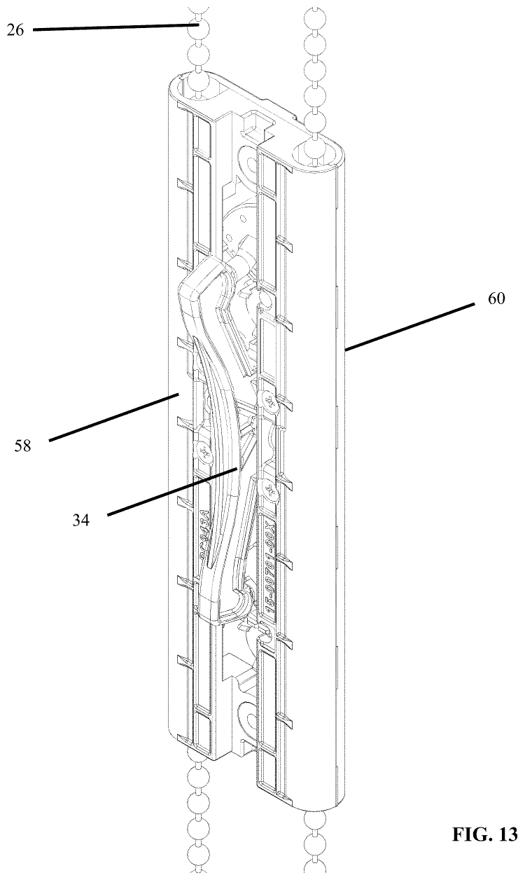

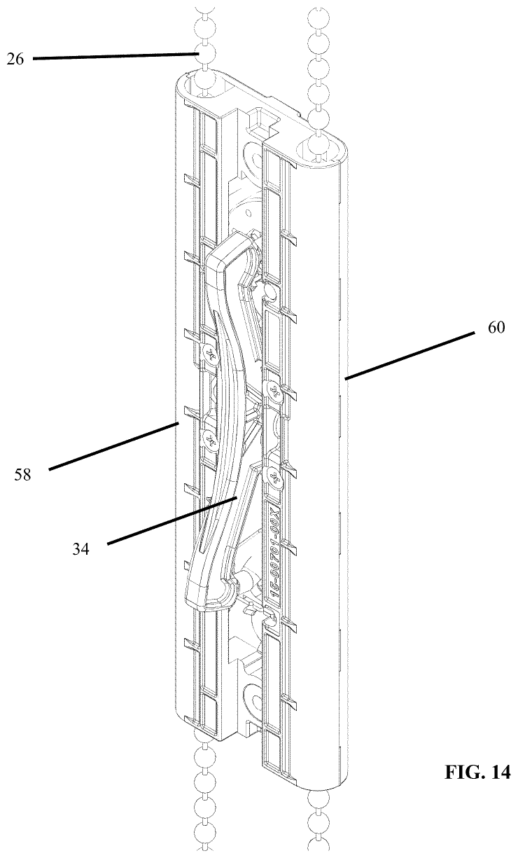

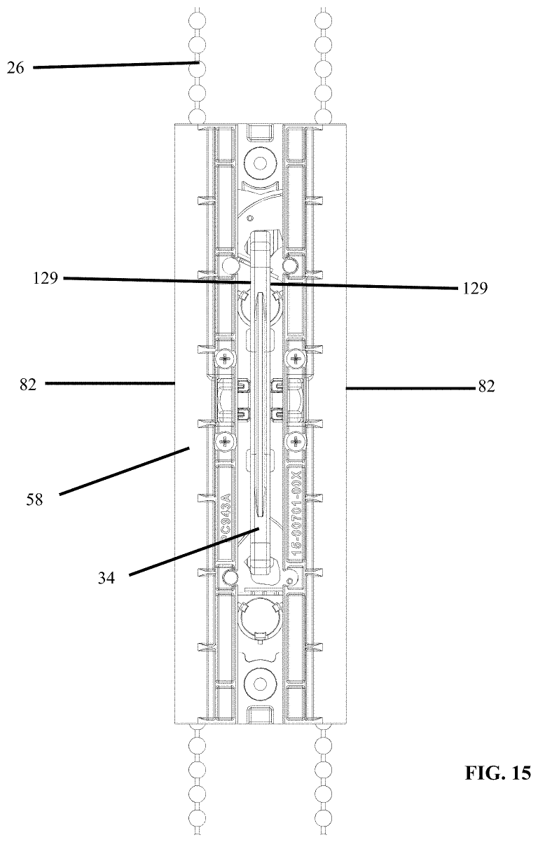

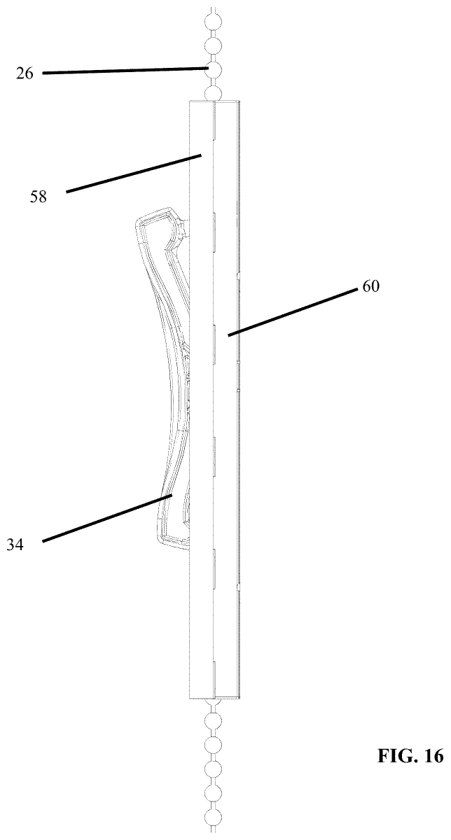

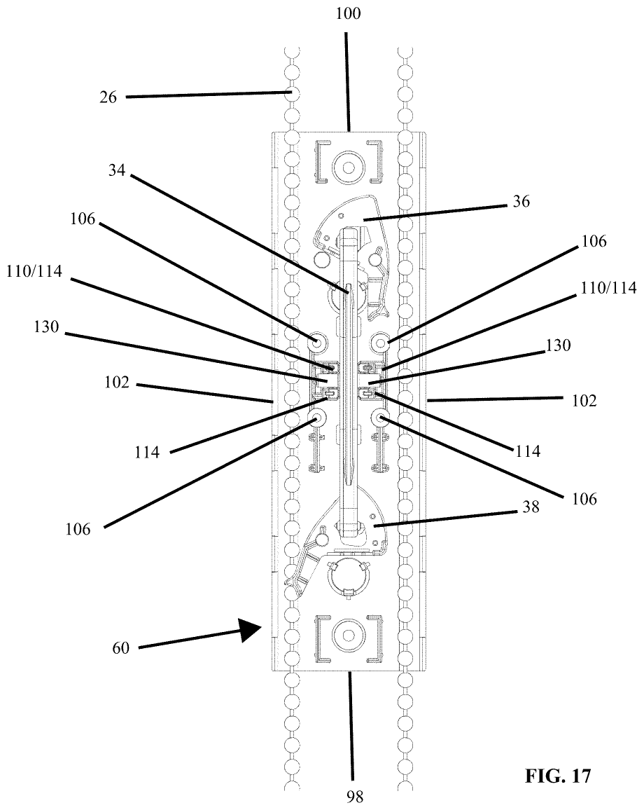

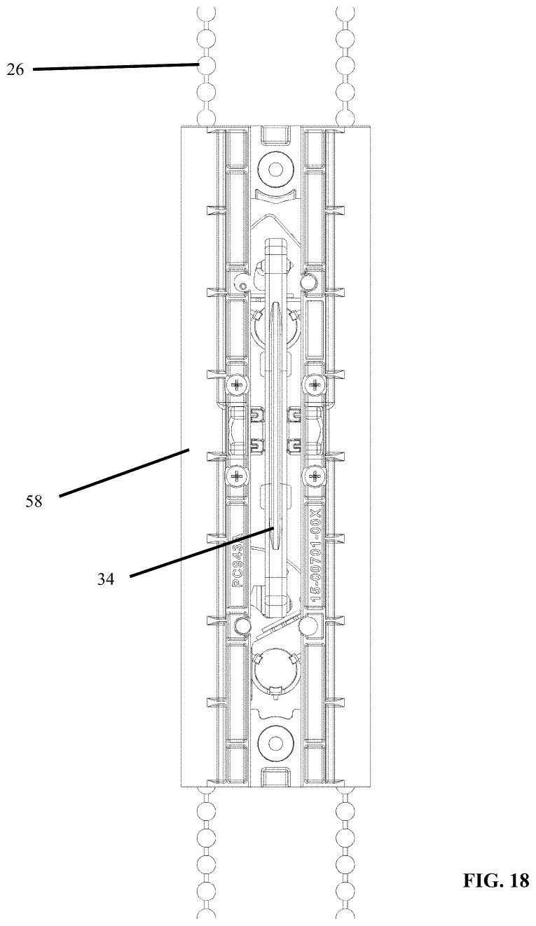

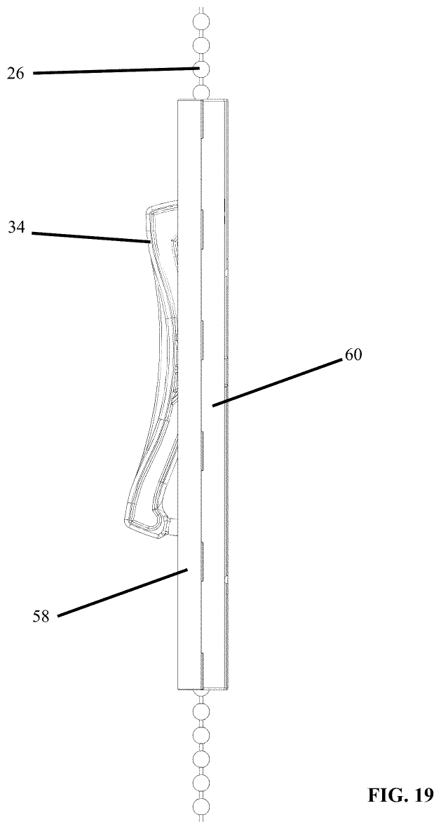

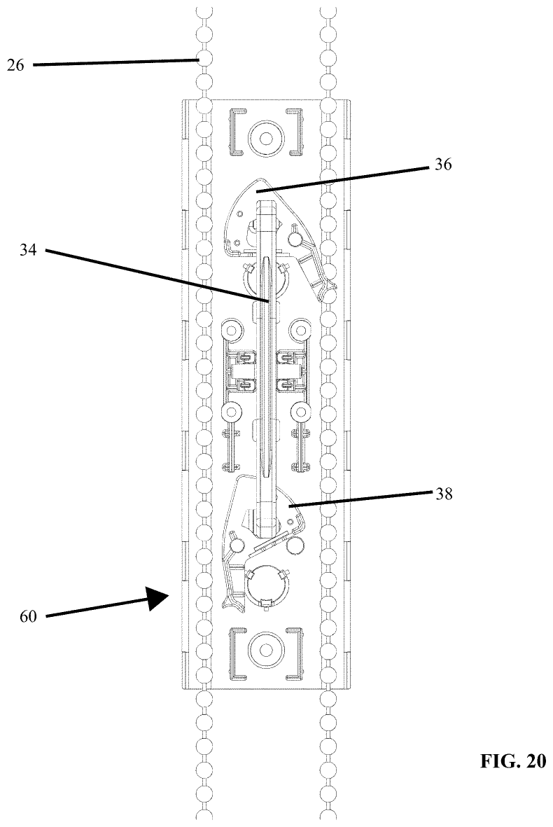

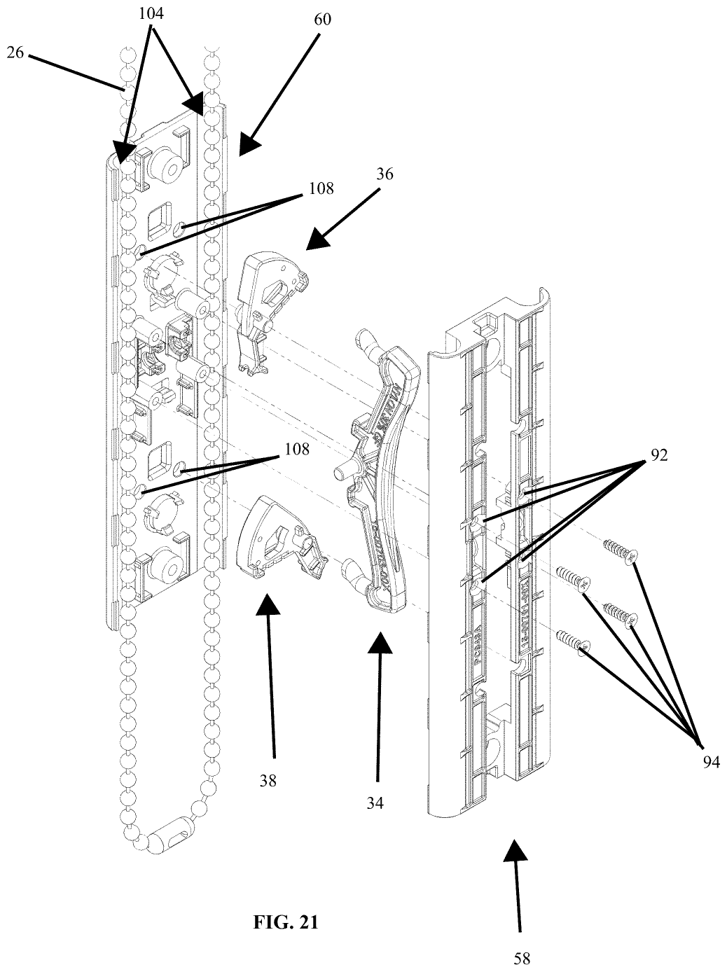

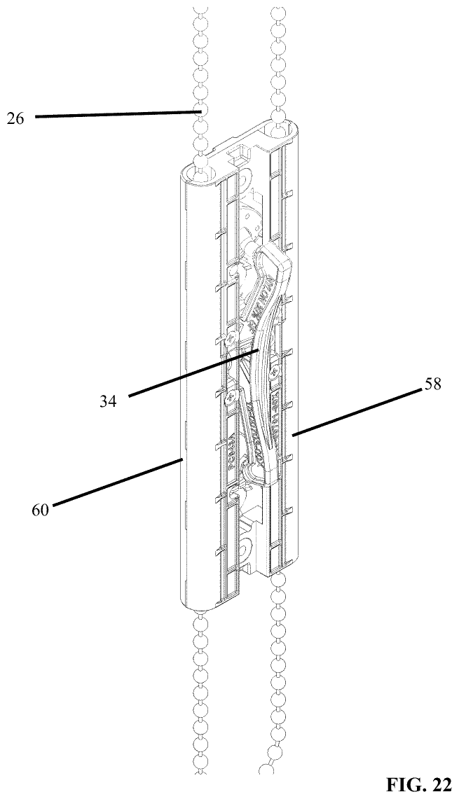

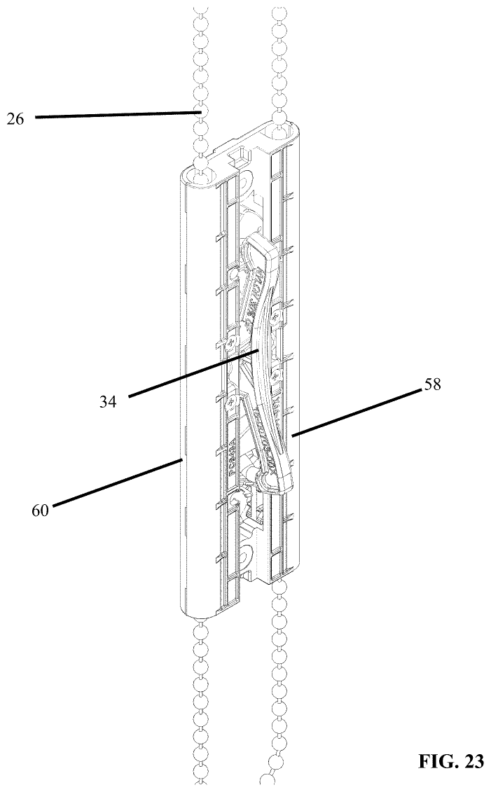

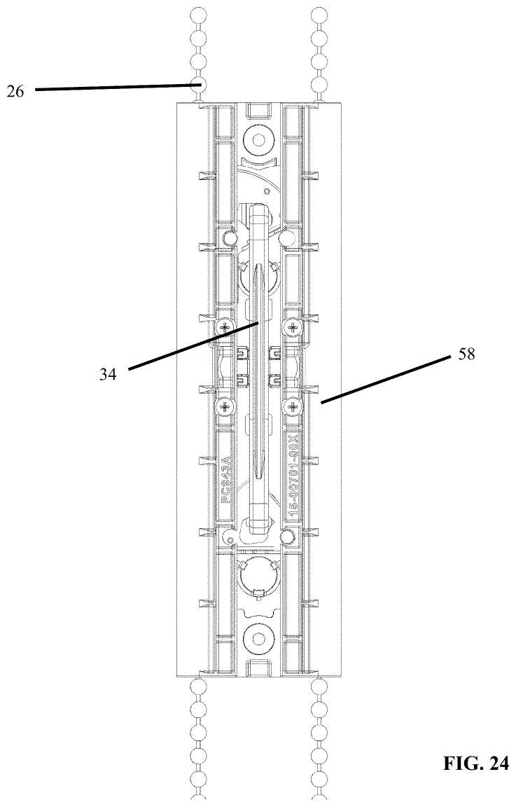

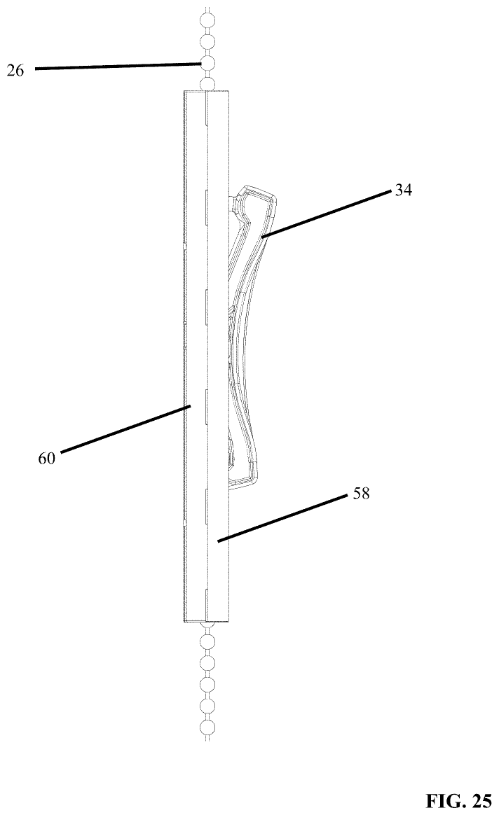

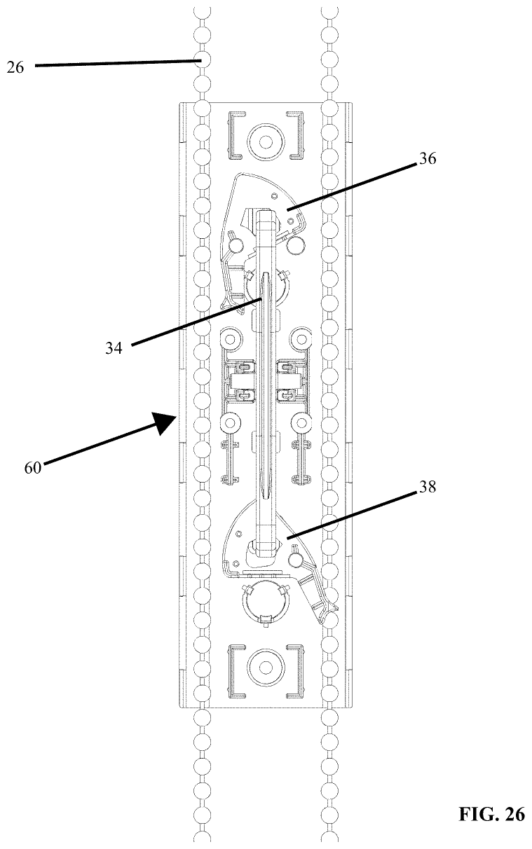

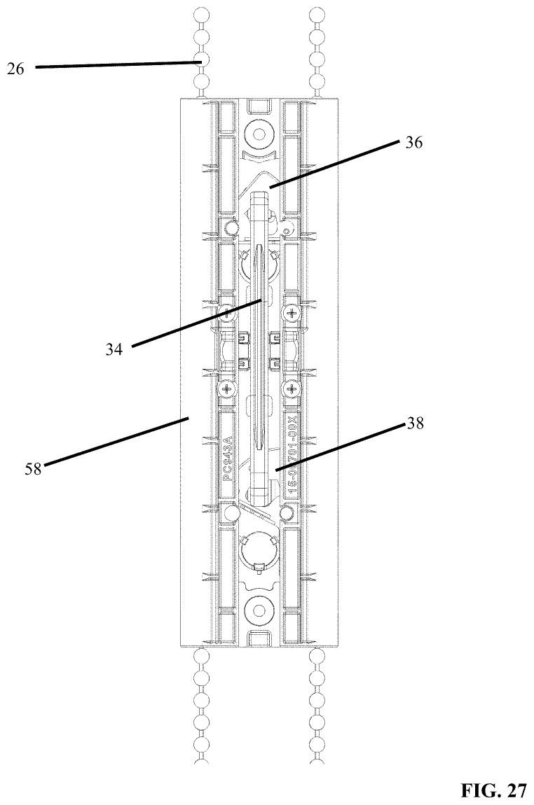

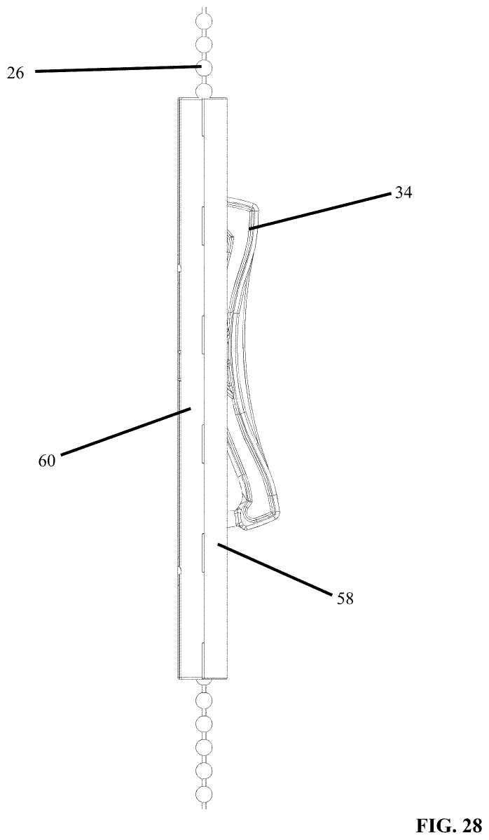

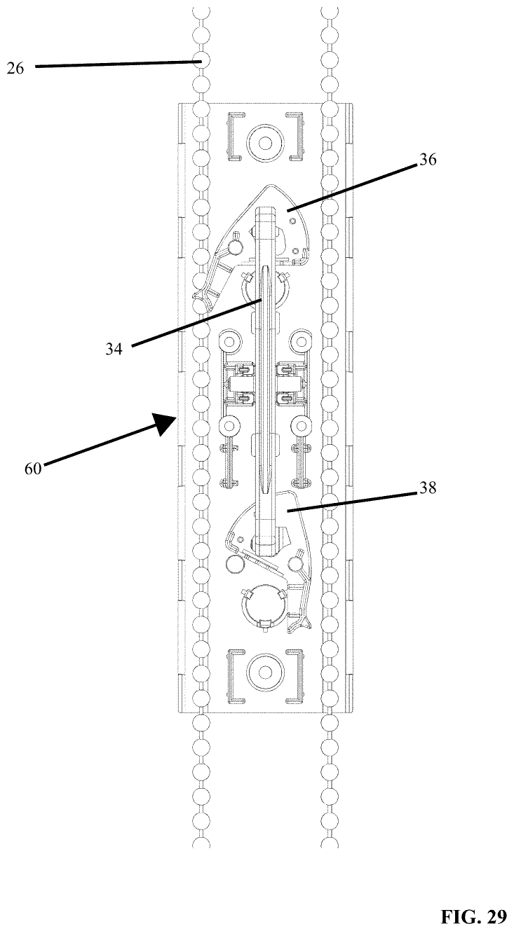

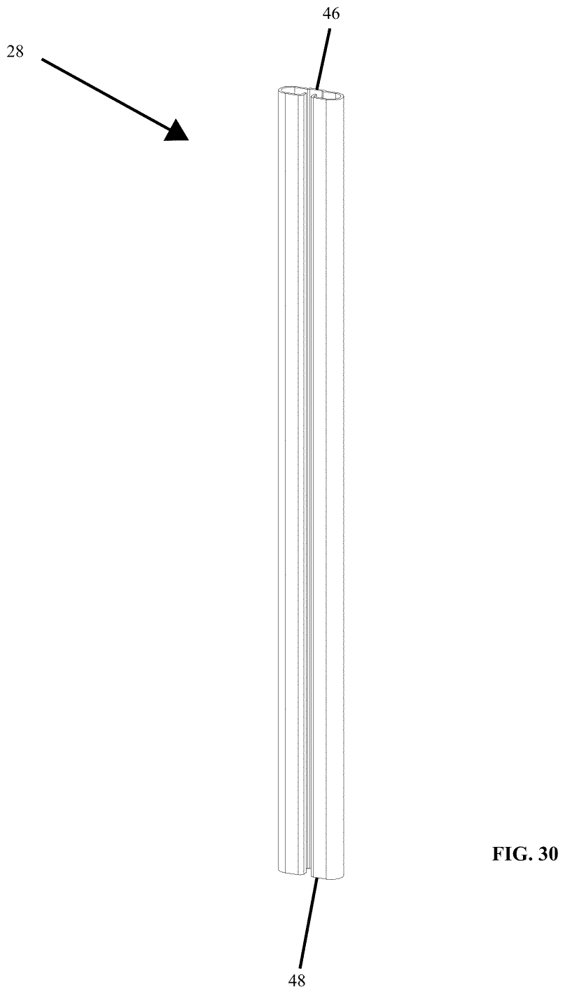

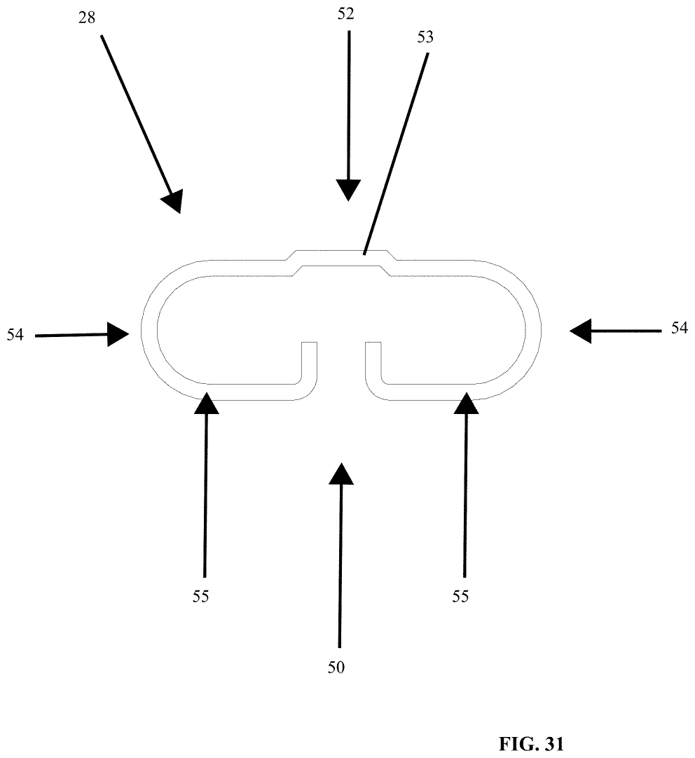

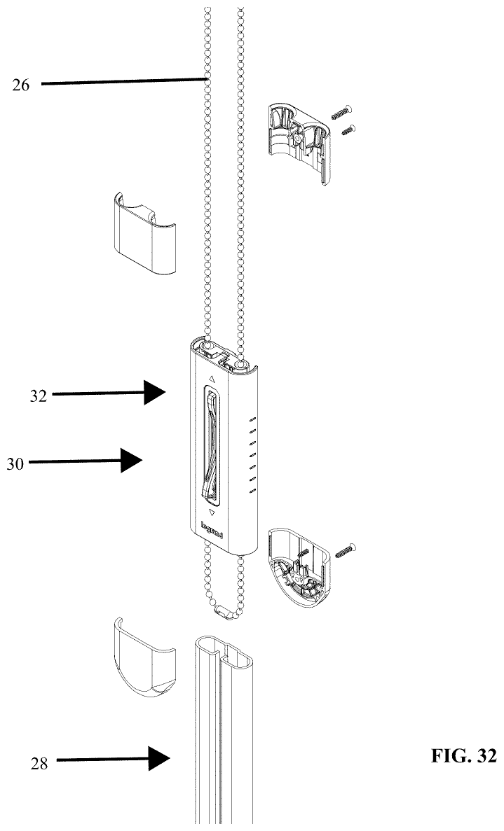

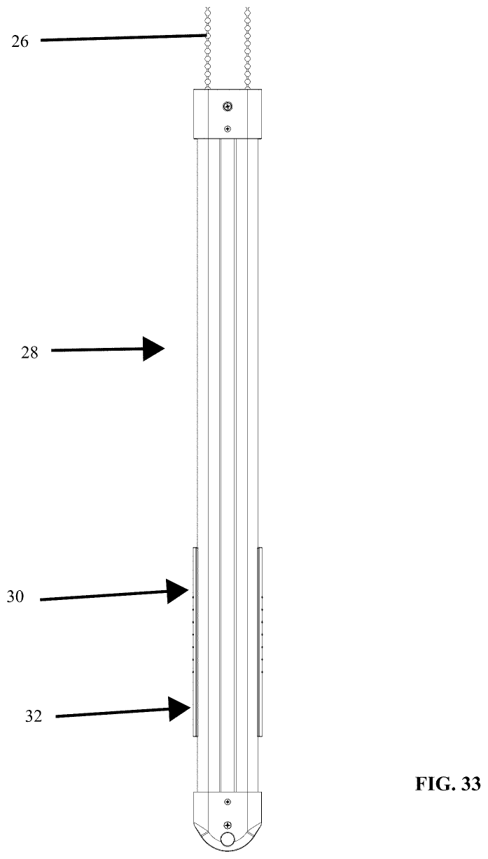

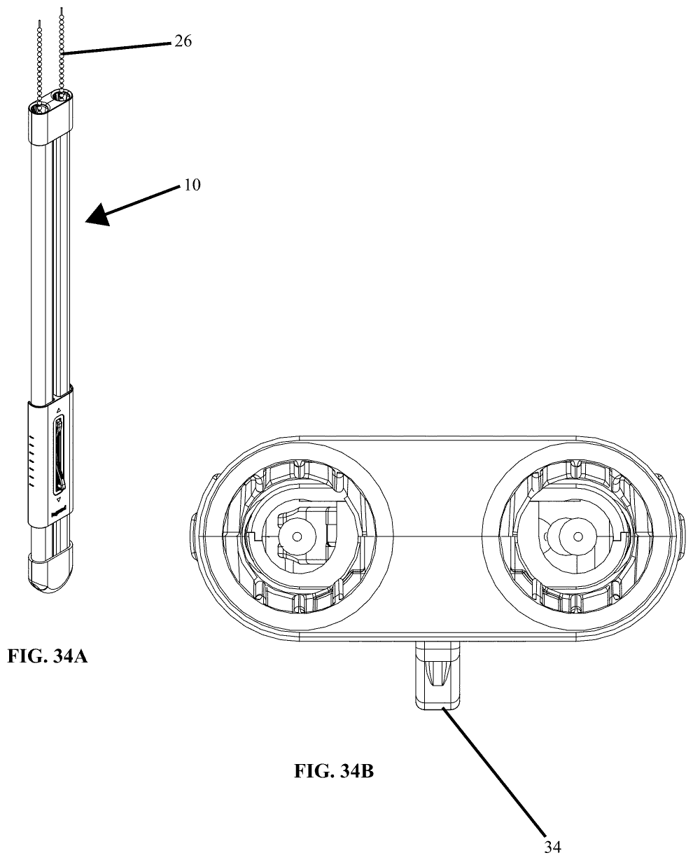

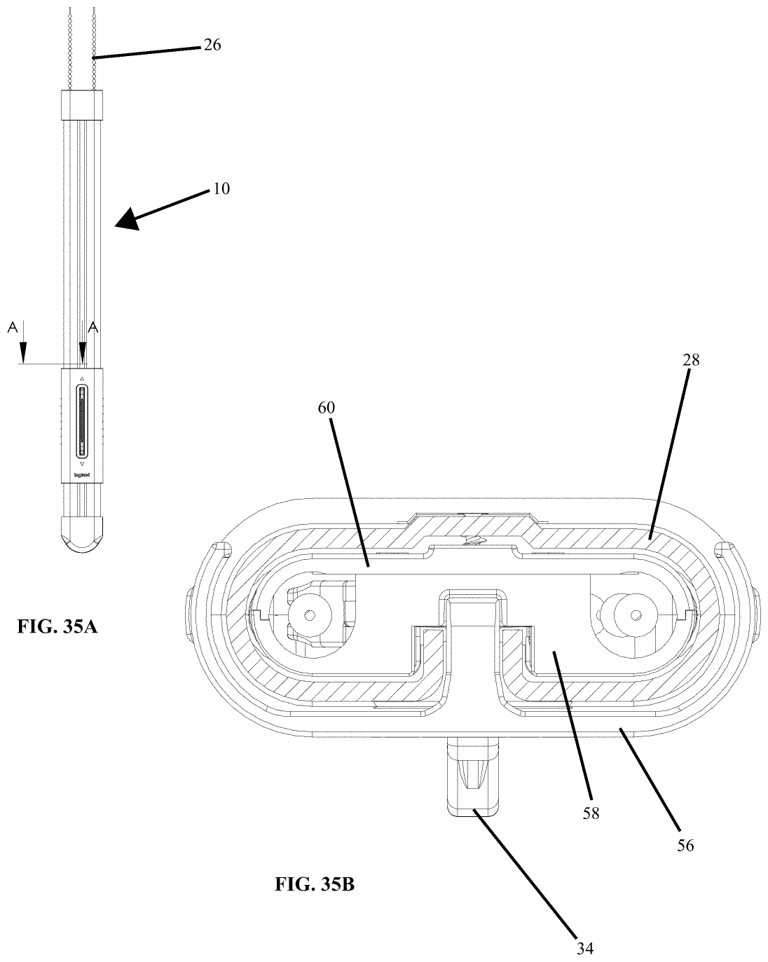

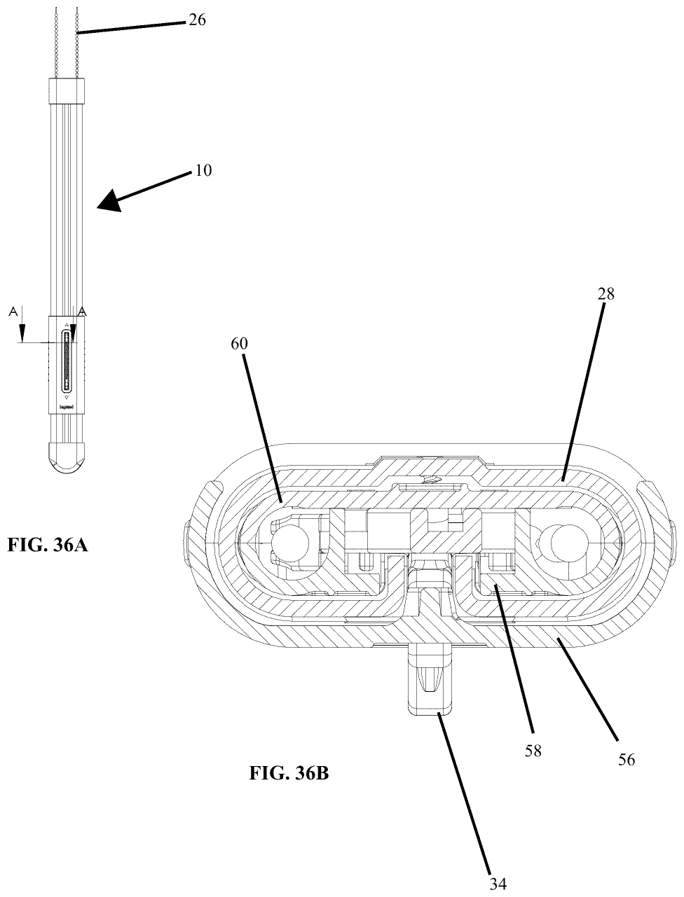

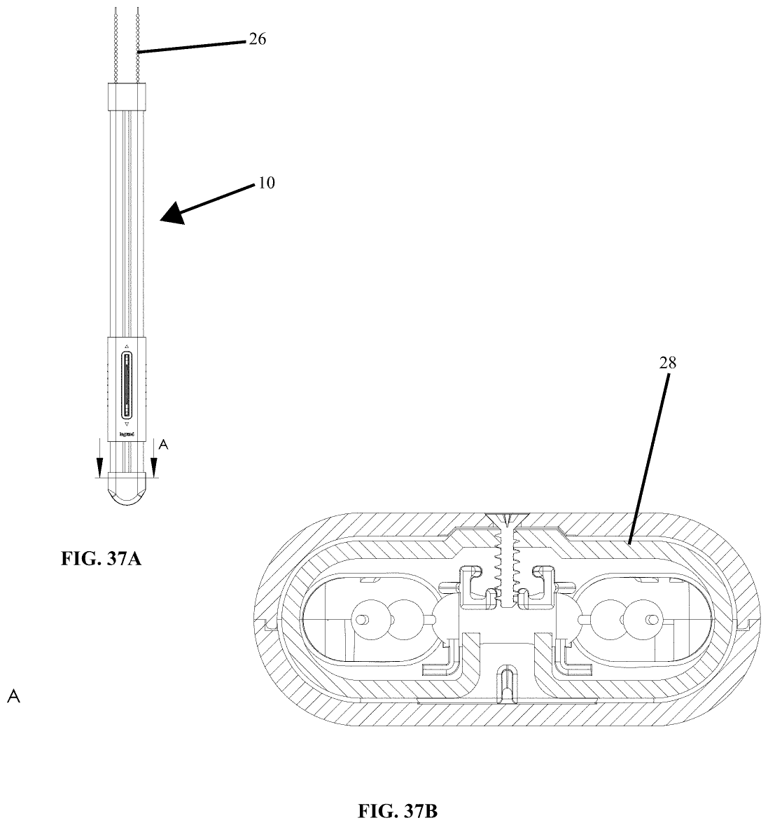

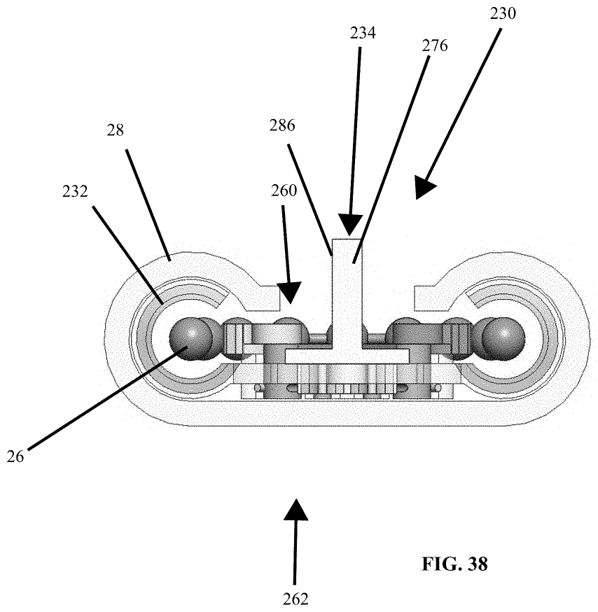

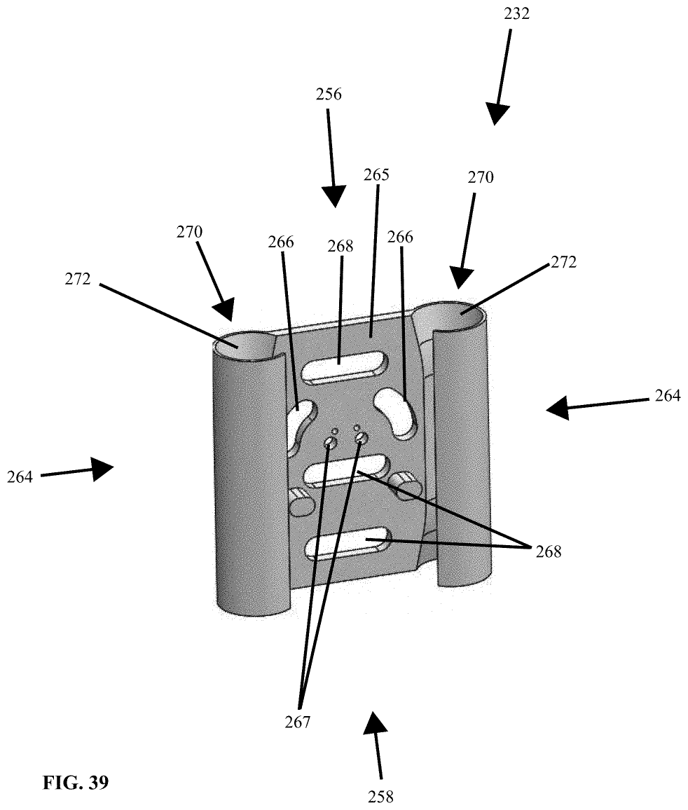

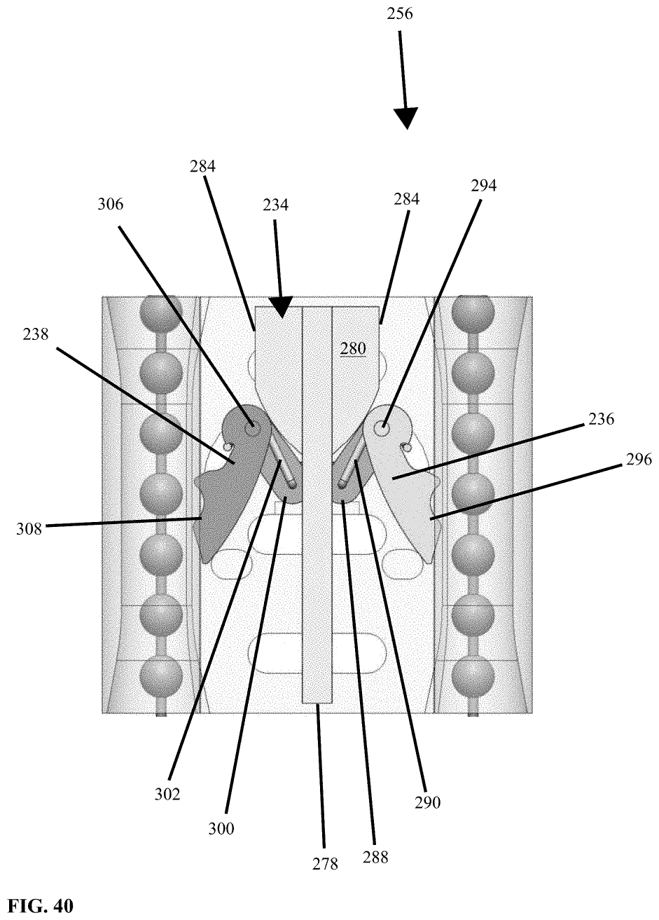

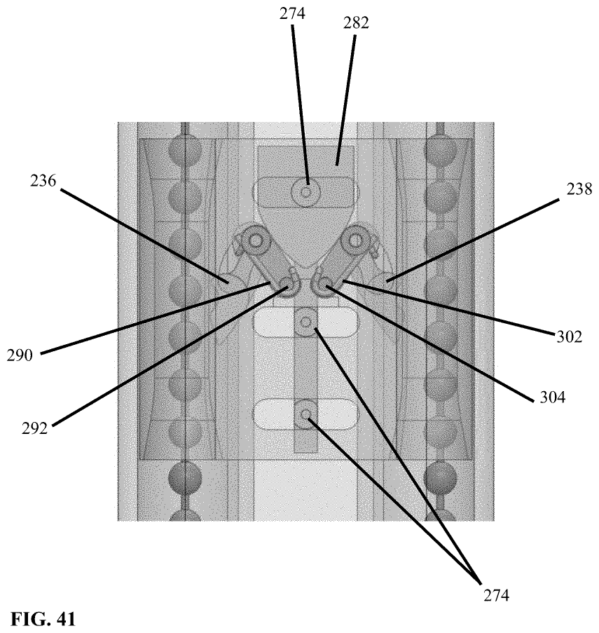

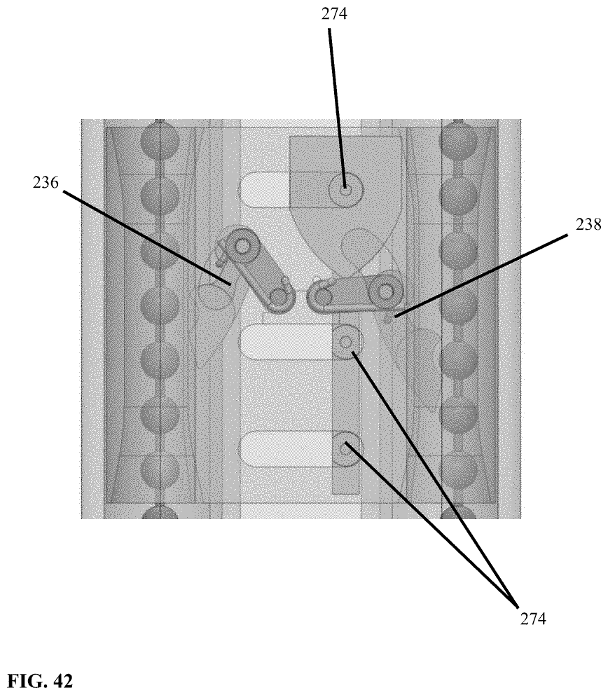

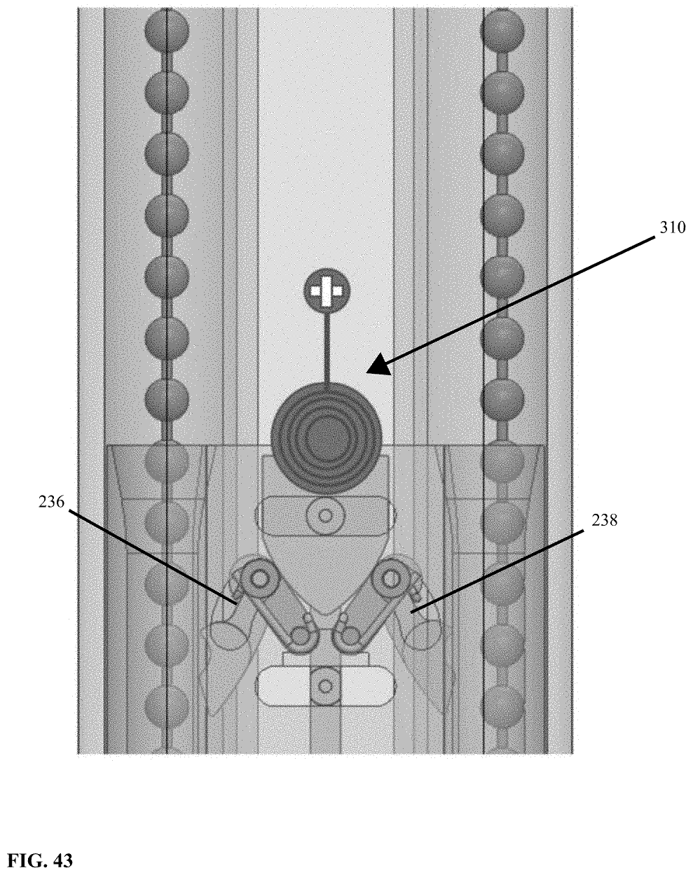

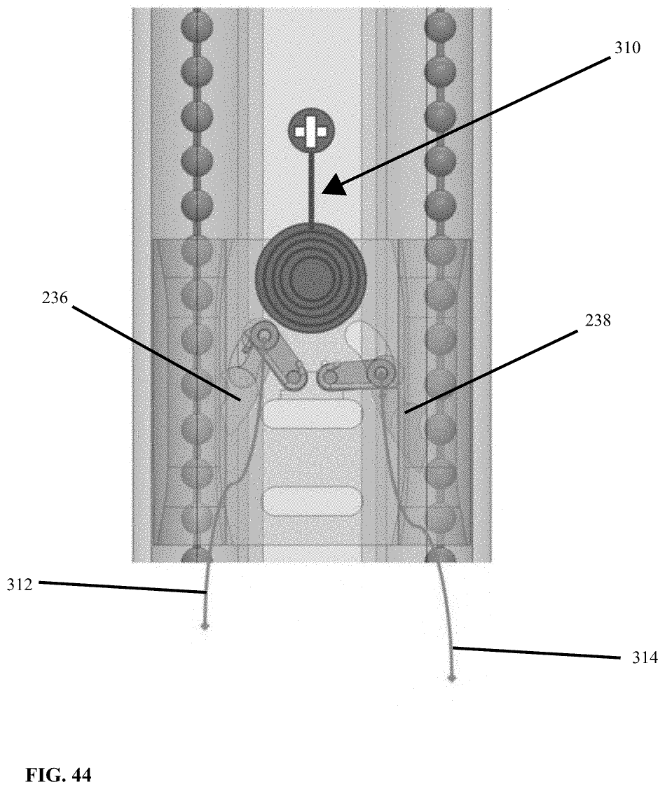

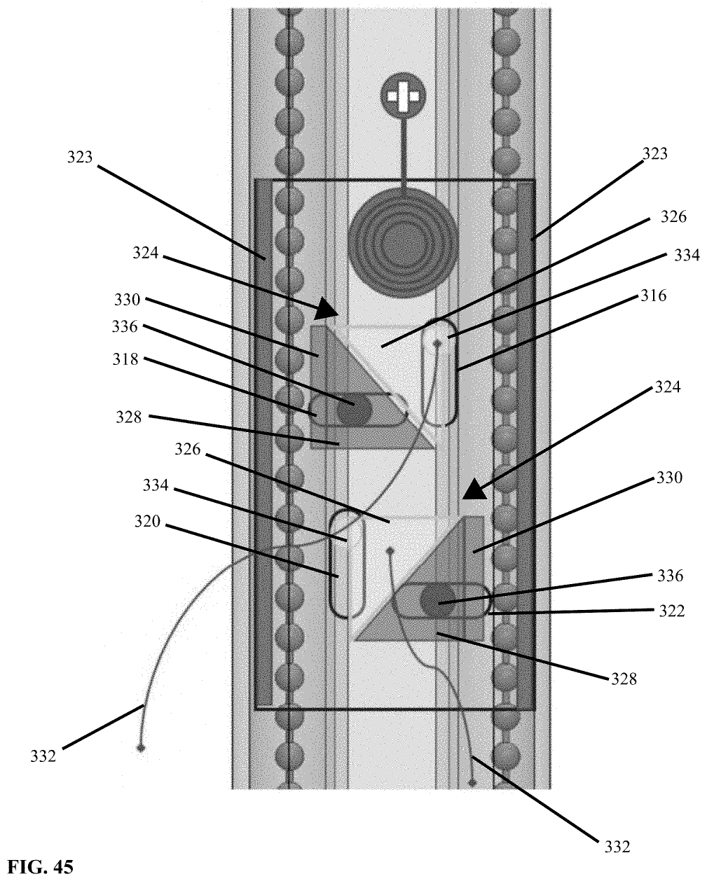

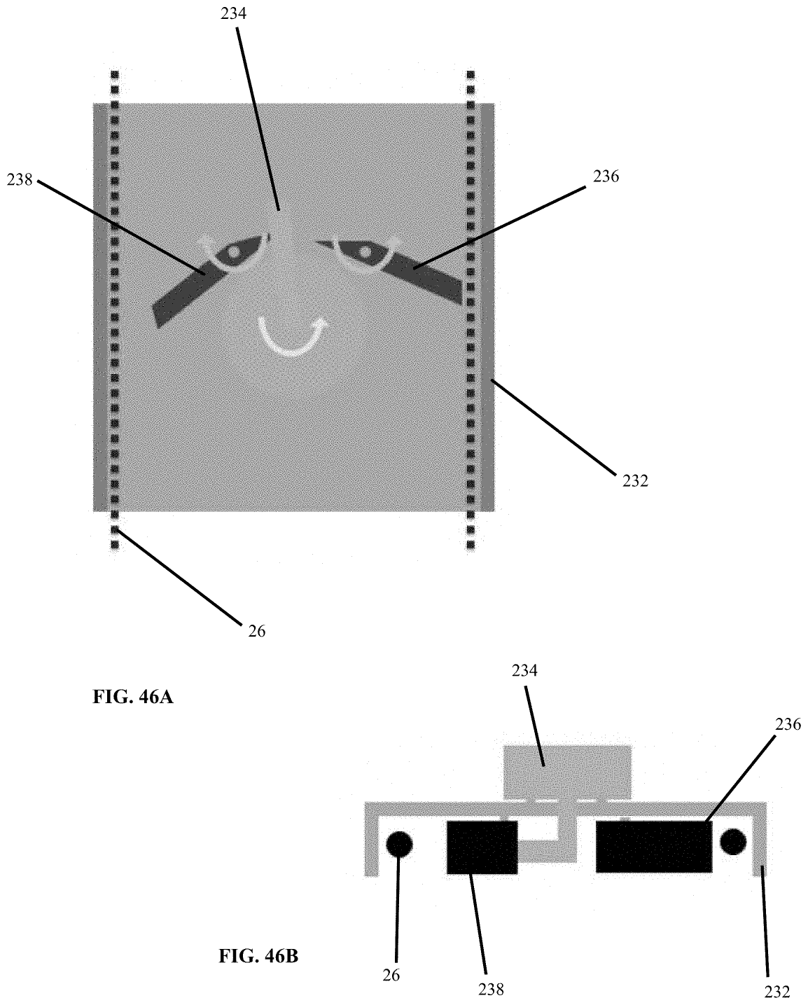

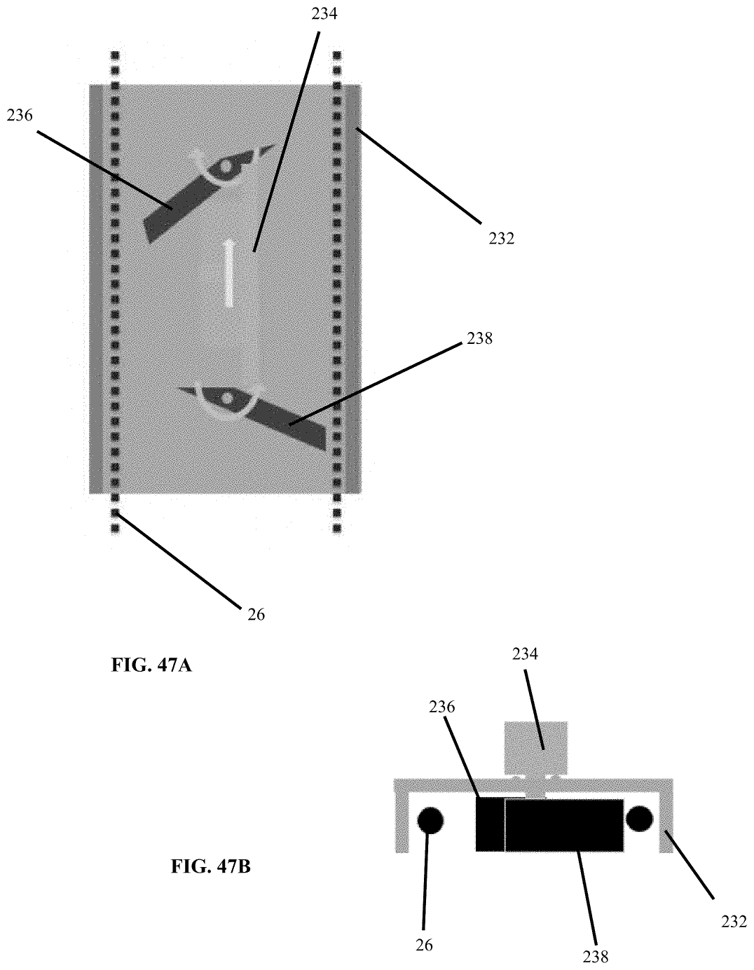

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of window shade systems. However, the embodiments are not so limited. It is appreciated that the embodiments may be adapted for use with other types of window treatments as well as in other applications which may be improved by the disclosed structures, arrangements and/or methods. The system is merely shown and described as being used in in the context of window shade systems for ease of description and as one of countless examples.

Window Shade System:

In the arrangement shown, as one example, system 10 is configured to be used on a window shade system 22. Window shade system 22 is formed of any suitable size, shape, and design and is configured to connect to a window head or window jamb and facilitate the raising or lowering of shade material 24 to provide shade to interior portions of a building. In the arrangement shown, as one example, the window shade system 22 includes shade material 24, a beaded chain 26, a roller tube (not shown), and a clutch (not shown). Window shade system 22 may be formed of additional components including mounting brackets, hem bars or other weighted bars or components to pull shade material 24 tight. Window shade system 22 can be connected to the window opening using a number of processes, such as through screwing, drilling, nailing, adhering, or any other means or method for attachment. While window shade system 22 has been described according to the arrangement shown as one example, any combination or arrangement may be used and is hereby contemplated for use in order to facilitate the provision of shade to interior portions of a building.

Shade Material: In the arrangement shown, as one example, window shade system 22 includes shade material 24. Shade material 24 is formed of any suitable size, shape, and design and is configured to provide shade to interior portions of a building. Shade material 24 may be formed of a number of different fabric materials including, by way of example and not limitation, polyester, cotton, linen, vinyl, fiberglass, or any other fabric material or combination of fabric materials. In the arrangement shown, as one example, shade material 24 is raised and lowered by rolling and unrolling the shade material 24 from the roller tube (not shown).

Roller Tube: In the arrangement shown, as one example, window shade system 22 includes a roller tube (not shown). Roller tube is formed of any suitable size, shape, and design and is configured to facilitate the raising or lowering of shade material 24. In one arrangement, as one example, roller tube is a generally elongated member, extending between opposing ends. In one arrangement, as one example, when viewed from an end, the roller tube is generally circular in shape. In one arrangement, as one example, when roller tube is rolled, the shade material 24 is raised or lowered. That is, in one arrangement if shade material 24 hangs down over the front of the roller tube, when the roller tube is rotated counterclockwise, shade material 24 is raised towards an open position. Conversely, using the same example, when the roller tube is rotated clockwise, shade material 24 is lowered towards a closed position. In the arrangement shown, as one example, roller tube is rolled when a user applies a downward force to the beaded chain 26.

Beaded Chain. In the arrangement shown, as one example, window shade system 22 includes beaded chain 26. Beaded chain 26 is formed of any suitable size, shape, and design and is configured to operatively connect to the roller tube of the window shade system 22 to facilitate the raising or lowering of shade material 24. In the arrangement shown, as one example, beaded chain 26 is formed of a metallic material and consists of a series of balls or beads which are linked together to form a continuous loop. In the arrangement shown, as one example, the top of beaded chain 26 connects to a clutch (not shown). The clutch includes a stationary portion and a rotatable portion, with the rotatable portion configured to be inserted into the roller tube, thereby operatively connecting beaded chain 26 to the roller tube. Thus, when a user applies a downward force to either the front side or the back side of the continuous loop formed by beaded chain 26, the front side or the back side moves downward, which causes the rotatable portion of the clutch and the roller tube of window shade system 22 to rotate, thereby raising or lowering shade material 24.

In various arrangements, as examples, the continuous loop formed by beaded chain 26 hangs down from the roller tube of the window shade system 22 and is uncovered and exposed for anyone or anything to access. Depending on the length, beaded chain 26 can hang down to a height low enough for animals and young children to reach. Because they may be able to reach beaded chain 26, children and animals may get caught in beaded chain 26 and become seriously injured. Because of this safety issue, there is a need in the art to enclose beaded chain 26, in order to eliminate this safety hazard, while also enabling a user to raise and lower shade material 24 without having direct access beaded chain 26 to apply a downward force to beaded chain 26.

In one or more arrangements where actuator system 10 is utilized, beaded chain 26 is positioned at least partially within cover 28 in order to eliminate the safety hazard. In one or more arrangements, actuator mechanism 30 is configured to allow a user to raise and lower shade material 24 without having direct access to beaded chain 26.

Actuator System for Window Shades:

With reference to the figures, an actuator system for window shades 10 (or actuator system 10 or simply “system 10”) is presented. System 10 is formed of any suitable size, shape, and design and is configured to operatively connect to a window shade system 22 and facilitate opening, closing, or otherwise adjusting of the window shade system 22 (e.g., raising and/or lowering of shade material 24 of shade system 22). In the arrangement shown, as one example, system 10 has a top end 12, a bottom end 14, a front side 16, a back side 18, and right and left ends 20 (or simply “opposing ends 20”). In the arrangement shown, as one example, system 10 includes a cover 28 and an actuator mechanism 30 having a carrier 32, a selector 34, a first ratchet member 36, and a second ratchet member 38 among other components. While system 10 has been described according to the arrangement shown, as one example, any combination or arrangement may be used and is hereby contemplated for use.

Not Limited to Shade Systems or Beaded Chain: Although various arrangements of system 10 may be primarily described and/or illustrated in the context of window shade systems, the embodiments are not so limited. Rather, it is contemplated that actuator system 10 may be adapted for use with various different types of window treatments known in the art including but not limited to shades, blinds, drapery, and/or any other type of window treatment. Similarly, although in some arrangements system 10 may be primarily described with reference to window treatments utilizing beaded chains for actuation, the embodiments are not so limited. Rather, it is contemplated that actuator system 10 may be adapted to facilitate adjustment of various different types of actuators known in the art including but not limited to, a beaded chain, a link chain, cords, cables, or any other similarly operated actuator.

Cover:

In the arrangement shown, as one example, system 10 includes cover 28. Cover 28 is formed of any suitable size, shape, and design and is configured to at least partially enclose beaded chain 26 therein and partially enclose actuator mechanism 30, while also allowing a user to utilize actuator mechanism 30. In the arrangement shown, as one example, cover 28 includes a top end 46, bottom end 48, front side 50, back side 52, and left and right sides 54 (or simply “sides 54”). In one or more arrangements, cover 28 may be formed of a single, unitary member that is formed in a manufacturing process such as extrusion, molding, pressing, forming, additive manufacturing, machining, or the like to form a unitary and monolithic member. Alternatively, in one or more arrangements, cover 28 may be formed of multiple pieces that are connected or assembled to one another such as through screwing, bonding, adhering, interlocking, friction fitting, or the like. In the arrangement shown, as one example, cover 28 is formed primarily of non-metallic materials. As examples, cover 28 may be formed of a plastic material, a composite material, a fiberglass material, or any other non-metallic material, and cover 28 may also be formed of a metallic material if desirable, such as stainless steel, chromium, aluminum, or any other metallic material, and/or composites thereof.

In the arrangement shown, as one example, cover 28 extends a length from top end 46 to bottom end 48. In various applications, the length of cover 28 may vary depending upon the length of the window shade system 22 and the length of the beaded chain 26 needed to raise and lower shade material 24. In the arrangement shown, as one example, cover 28 is formed using the process of extrusion and is extruded to an arbitrary length. In this arrangement, as one example, when cover 28 is installed on a window shade system 22, the required length of cover 28 is measured and cover 28 is then cut down to that length and installed. In this way, cover 28 can be customizable to the window shade system 22 upon which the system 10 is being installed at the time of installation thereby providing unparalleled customization and flexibility. In an alternative arrangement, as one example, cover 28 is formed using the process of extrusion, or any other manufacturing process for that matter such as molding, machining, fabricating, bending, welding, or the like or any combination thereof, but the required length of cover 28 is predetermined and cover 28 is manufactured to the predetermined length, or cut to the predetermined length at the OEM factory. In this way, cover 28 as provided from the factory is matched with and optimized to window shade system 22 and is ready to install without any further adjustments, but adjustments can still be made to cover 28 if actual conditions on the specific window shade system 22 require such adjustments upon installation in the field.

In the arrangement shown, as one example, when viewed from back side 52, cover 28 is generally rectangular in shape, with top end 46 and bottom end 48 extending in approximate parallel planar spaced relation, and with sides 54 extending in approximate parallel planar spaced relation. In the arrangement shown, as one example, when viewed from top end 46 or bottom end 48, cover 28 includes semi-enclosed channels 55 on each side 54, which are connected by a mostly planar surface 53 extending between the semi-enclosed channels 55 on the back side 52 of cover 28. In the arrangement shown, as one example, when viewed from top end 46 or bottom end 48, the semi-enclosed channels 55 on each side 54 are generally circular or curved, however any other shape, design, or configuration can be used and is hereby contemplated for use as semi-enclosed channels 55. In the arrangement shown, as one example, beaded chain 26 is positioned at least partially within cover 28, with one side of the loop formed by beaded chain 26 resting in one of the semi-enclosed channels 55 on one side 54 of cover 28, and the other side of the loop formed by beaded chain 26 resting in the other semi-enclosed channel 55 on the other side 54 of cover 28.

In the arrangement shown, as one example, when viewed from top end 46 or bottom end 48, there is an open area between the semi-enclosed channels 55. The open area of cover 28 is formed of any suitable size, shape, and design and is configured to allow proper operation of actuator 30 when cover 28 and actuator mechanism 30 are in connection with one another, and more specifically allowing selector 34 to be positioned at least partially outside cover 28 and operably connected to first ratchet member 36 and second ratchet member 38 while at least a portion of actuator 30 is positioned within cover 28. In this way, cover 28 allows for the at least partial enclosure of beaded chain 26 and the partial enclosure of actuator mechanism 30, while also allowing a user to access and use actuator mechanism 30 to raise and lower shade material 24.

Actuator Mechanism 30:

In the arrangement shown, as one example, system 10 includes actuator mechanism 30. Actuator mechanism 30 is formed of any suitable size, shape, and design and is configured to allow a user to effectively apply a force to beaded chain 26 in order to raise or lower shade material 24. In the arrangement shown, as one example, actuator mechanism 30 is configured to apply a downward force to beaded chain 26 in order to raise or lower shade material 24. However, the arrangements are not so limited. Rather, it is contemplated that in one or more arrangements, actuator mechanism 30 may be configured to conversely or additionally apply an upward force to beaded chain 26 in order to raise or lower shade material 24.

In the arrangement shown, as one example, actuator mechanism 30 is formed of multiple parts, including carrier 32, selector 34, first ratchet member 36, and second ratchet member 38. In various arrangements, the multiple parts of actuator mechanism 30 may be operably connected and/or assembled to one another such as through screwing, bolting, bonding, adhering, riveting, interlocking, friction fitting, or the like. While actuator mechanism 30 has been described according to the arrangement shown as one example, any combination or arrangement may be used and is hereby contemplated for use in order to allow a user to effectively apply a downward force to beaded chain 26 in order to raise or lower shade material 24.

Carrier: In the arrangement shown, as one example, actuator mechanism 30 includes carrier 32. Carrier 32 is formed of any suitable size, shape, and design and is configured to fit at least partially within cover 28 and facilitate connection between selector 34 and first ratchet member 36 and second ratchet member 38. In the arrangement shown, as one example, carrier 32 has a front plate 56, an intermediate plate 58, and a rear plate 60. In the arrangement shown, as one example, carrier 32 is a generally rectangular member and front plate 56, intermediate plate 58, and rear plate 60 are connected using fasteners, such as screws or bolts, and/or friction fitting, however any other means of connection may be used in order to join the various pieces of carrier 32. In the arrangement shown, as one example, the various components of carrier 32 are formed primarily of a non-metallic material such as a plastic material or a composite material, however any other non-metallic or metallic material may be used and is hereby contemplated for use to form the various components of carrier 32.

In the arrangement shown, as one example, intermediate plate 58 and rear plate 60 fit at least partially within cover 28 while front plate 56 is primarily located outside of cover 28. That is, intermediate plate 58 and rear plate 60 are sized and shaped such that they generally fit within cover 28 and, more specifically, within the semi-enclosed channels 55 of cover 28. In the arrangement shown, as one example, front plate 56 is generally positioned outside of cover 28 and connects to intermediate plate 58 at a position such that a portion of front plate 56 extends through the space between the semi-enclosed channels 55 in order to connect to intermediate plate 58 while intermediate plate 58 is located primarily within cover 28.

Front Plate 56: In the arrangement shown, as one example, carrier 32 includes front plate 56. Front plate 56 is formed of any suitable size, shape, and design and is configured to connect to intermediate plate 58 and allow access to and operation of selector 34. In the arrangement shown, as one example, front plate 56 includes a top end 62, bottom end 64, opposing right and left sides 66 (or simply “sides 66”), semi-enclosed channels 68, a slot 70, indicia 72, and tabs 74.

In the arrangement shown, as one example, front plate 56 is generally rectangular in shape, extending a length between top end 62 and a width bottom end 64 and between opposing sides 66. In the arrangement shown, as one example, front plate 56 includes semi-enclosed channels 68 at each of the opposing sides 66 of front plate 56. In the arrangement shown, as one example, semi-enclosed channels 68 are sized and shaped to extend at least partially around the exterior of the semi-enclosed channels 55 of cover 28. That is, in the arrangement shown as one example, semi-enclosed channels 68 of front plate 56 of carrier 32 are sized and positioned to cover a portion of the semi-enclosed channels 55 of cover 28 while still allowing carrier 32 to move up and down with relatively little friction between front plate 56 and cover 28.

In the arrangement shown, as one example, front plate 56 includes a slot 70 positioned at or near a midpoint between the sides 66 of front plate 56 and extending from near top end 62 to near bottom end 64. Slot 70 is formed of any suitable size, shape, and design and is configured to allow selector 34 to extend therethrough such that selector 34 can operably connect to first ratchet member 36 and second ratchet member 38, while still allowing a user to access selector 34 from the outside of carrier 32. That is, selector 34 must be positioned on the outer side of front plate 56 in order for a user to access and operate selector 34, and selector 34 must extend into carrier 32 to operably connect to first ratchet member 36 and second ratchet member 38.

In the arrangement shown, as one example, front plate 56 also includes indicia 72, which are positioned above and below slot 70. Indicia 72 are formed of any suitable size, shape, and design and are configured to indicate to a user which way shade material 24 will move based on the position of selector 34. In the arrangement shown, as one example, indicia 72 are simply arrows pointing up or down to indicate whether shade material 24 will move up or down when the selector 34 is in a certain position.

In the arrangement shown, as one example, front plate 56 includes tabs 74. Tabs 74 are formed of any suitable size, shape, and design and are configured to help facilitate alignment between front plate 56 and intermediate plate 58. In the arrangement shown, as one example, tabs 74 extend rearward from front plate 56 toward intermediate plate 58 and are configured to align with indents 88 of intermediate plate 58 and engaged with indents 88 in order to help hold front plate 56 and intermediate plate 58 together in proper alignment.

Intermediate Plate 58: In the arrangement shown, as one example, carrier 32 includes intermediate plate 58. Intermediate plate 58 is formed of any suitable size, shape, and design and is configured to connect to front plate 56 and rear plate 60 and facilitate the enclosure of first ratchet member 36 and second ratchet member 38. In the arrangement shown, as one example, intermediate plate 58 includes a top end 78, bottom end 80, opposing right and left sides 82 (or simply “sides 82”), partial channels 84, slot 86, indent 88, recesses 90, and openings 92.

In the arrangement shown, as one example, intermediate plate 58 is generally rectangular in shape, extending a length between top end 78 and bottom end 80 and a width between opposing sides 82. In the arrangement shown, as one example, intermediate plate 58 includes partial channels 84 at each of the opposing sides 82 of intermediate plate 58. In the arrangement shown, as one example, partial channels 84 are configured to connect to partial channels 104 of rear plate 60 in order to enclose a portion of beaded chain 26. Additionally, partial channels 84 of intermediate plate 58 are configured to fit within semi-enclosed channels 55 of cover 28 in order for intermediate plate 58 to be primarily positioned within cover 28.

In the arrangement shown, as one example, intermediate plate 58 includes slot 86. Slot 86 is formed of any suitable size, shape, and design and is configured to allow selector 34 to extend therethrough to operably connect to first ratchet member 36 and second ratchet member 38. In the arrangement shown, as one example slot 86 is positioned at or near a midpoint between the sides 82 of intermediate plate 58 and extends from near top end 78 to near bottom end 80. In the arrangement shown, as one example, selector 34 extends through slot 86 such that the front side of selector 34 is located outside front plate 56 while the rear side of selector 34 is located on the rear side of intermediate plate 58, between intermediate plate 58 and rear plate 60.

In the arrangement shown, as one example, intermediate plate 58 includes connection members 87. Connection members 87 are formed of any suitable size, shape, and design and are configured to connect the partial channels 84 of intermediate plate 58 together and allow a number of fasteners 94 to pass through intermediate plate 58 to connect the various components of carrier 32. In the arrangement shown, as one example, there are two connection members 87, with one connection member located at the top end 78 of intermediate plate 58 and the other connection member 87 located at the bottom end 80 of intermediate plate 58. In the arrangement shown, as one example, connection members 87 are generally square or rectangular members which extend between the partial channels 84 of intermediate plate 58. In the arrangement shown, as one example, connection members 87 also include openings through which a number of fasteners 94 extend in order to help facilitate connection between each of front plate 56, intermediate plate 58, and rear plate 60.

In the arrangement shown, as one example, intermediate plate 58 includes indents 88. Indents 88 are formed of any suitable size, shape, and design and are configured to receive tabs 74 of front plate 56 therein in order to help facilitate alignment between front plate 56 and intermediate plate 58. In the arrangement shown, as one example, indents 88 are complimentary to tabs 74 such that when front plate 56 and intermediate plate 58 are brought together, the top end 62 of front plate 56 and the top end 78 of intermediate plate 58 form a generally flat and planar surface. Likewise, in the arrangement shown as one example, indents 88 are complimentary to tabs 74 such that when front plate 56 and intermediate plate 58 are brought together, the bottom end 64 of front plate 56 and the bottom end 80 of intermediate plate 58 form a generally flat and planar surface.

In the arrangement shown, as one example, intermediate plate 58 includes recesses 90. Recesses 90 are formed of any suitable size, shape, and design and are configured to help facilitate connection between first ratchet member 36 and intermediate plate 58 and second ratchet member 38 and intermediate plate 58. In the arrangement shown, as one example, recesses 90 are circular recesses in intermediate plate 58 which generally coincide in shape, size, and position with protrusions 146 of first ratchet member 36 and protrusions 160 of second ratchet member 38. In the arrangement shown, as one example, the protrusions 146 of first ratchet member 36 and the protrusions 160 of second ratchet member 38 extend outwardly from both the front and back sides of first ratchet member 36 and second ratchet member 38 and the forward-extending portion of protrusions 146 and protrusions 160 are configured to align with and be inserted into the recesses 90 of intermediate plate 58, while still allowing protrusions 146 and protrusions 160 to rotate about their center axes within recesses 90. In this way, recesses 90 help to facilitate alignment and operable connection between first ratchet member 36 and intermediate plate 58 and second ratchet member 38 and intermediate plate 58. In the arrangement shown, as one example, there are two recesses 90 located towards the bottom end 80 of intermediate plate 58 and two recesses 90 located towards the top end 78 of intermediate plate 58. However, any other number and layout of recesses 90 may be used in order to connect intermediate plate 58 to first ratchet member 36 and second ratchet member 38.

In the arrangement shown, as one example, intermediate plate 58 includes openings 92. Openings 92 are formed of any suitable size, shape, and design and are configured to receive fasteners 94 therein in order to connect various components of carrier 32 together. In the arrangement shown, as one example, intermediate plate 58 and rear plate 60 are held together by a number of fasteners 94 which extend through openings 106 of rear plate 60 and into openings 92 of intermediate plate 58. Additionally, in the arrangement shown as one example, a number of fasteners 94 extend through openings 106 of rear plate 60, through the openings in connection members 87 of intermediate plate 58 and into front plate 56 in order to join front plate 56, intermediate plate 58, and rear plate 60 to form carrier 32.

Rear Plate 60: In the arrangement shown, as one example, carrier 32 includes rear plate 60. Rear plate 60 is formed of any suitable size, shape, and design and is configured to connect to intermediate plate 58 and help facilitate the enclosure of first ratchet member 36 and second ratchet member 38. In the arrangement shown, as one example, rear plate 60 includes a top end 98, a bottom end 100, opposing right and left sides 102 (or simply “sides 102”), partial channels 104, openings 106, recesses 108, and engagement members 110.

In the arrangement shown, as one example, rear plate 60 is generally rectangular in shape, extending a length between top end 98 and bottom end 100 and a width between opposing sides 102. In the arrangement shown, as one example, rear plate 60 includes partial channels 104 at each of the opposing sides 102 of rear plate 60. In the arrangement shown, as one example, partial channels 104 are sized, shaped, and aligned to connect with partial channels 84 of intermediate plate 58 in order to enclose a portion of beaded chain 26. Additionally, partial channels 104 of rear plate 60 are configured to fit within semi-enclosed channels 55 of cover 28 in order for rear plate 60 to be primarily housed within cover 28.

In the arrangement shown, as one example, rear plate 60 includes openings 106. Openings 106 are formed of any suitable size, shape, and design and are configured to receive fasteners 94. In the arrangement shown, as one example, openings 106 are generally aligned with openings 92 of intermediate plate 58 such that fasteners 94 may extend through openings 106 and into openings 92. In the arrangement shown, as one example, with fasteners 94 extended through openings 106 and openings 92, rear plate 60 and intermediate plate 58 are connected.

In the arrangement shown, as one example, rear plate 60 includes recesses 108. Recesses 108 are formed of any suitable size, shape, and design and are configured to help facilitate connection between first ratchet member 36 and rear plate 60 and second ratchet member 38 and rear plate 60. In the arrangement shown, as one example, recesses 108 are circular recesses in rear plate 60 which generally coincide in shape and size with protrusions 146 of first ratchet member 36 and protrusions 160 of second ratchet member 38. In the arrangement shown, as one example, the protrusions 146 of first ratchet member 36 and the protrusions 160 of second ratchet member 38 extend outwardly from both the front and back sides of first ratchet member 36 and second ratchet member 38 and the backward-extending portion of protrusions 146 and protrusions 160 are configured to align with and be inserted into the recesses 108 of rear plate 60, while still allowing protrusions 146 and protrusions 160 to rotate about their center axes within recesses 108. In this way, recesses 108 help to facilitate alignment and operable connection between first ratchet member 36 and rear plate 60 and second ratchet member 38 and rear plate 60. In the arrangement shown, as one example, there are two recesses 108 located towards the bottom end 100 of rear plate 60 and two recesses 108 located towards the top end 98 of rear plate 60. However, any other number and layout of recesses 108 may be used in order to connect rear plate 60 to first ratchet member 36 and second ratchet member 38.

In the arrangement shown, as one example, rear plate 60 includes engagement members 110. Engagement members 110 are formed of any suitable size, shape, and design and are configured to facilitate operable engagement between selector 34 and rear plate 60. In the arrangement shown, as one example, there are two engagement members 110 and each engagement member 110 is formed of sidewalls 114 and an open center 116. In the arrangement shown, as one example, two sidewalls 114 extend outward a distance from rear plate 60 and open center 116 is located in between the sidewalls 114. In the arrangement shown, as one example, open center 116 is shaped and sized to receive engagement member 130 of selector 34 therein and hold engagement member 130 of selector 34 in close and tight tolerances. In the arrangement shown, as one example, engagement member 130 of selector 34 is held within engagement members 110 such that selector 34 may rotate about the center axis of engagement member 130 of selector 34 while still being held within engagement members 110 of rear plate 60. In this way, selector 34 is operably connected to rear plate 60 and carrier 32.

While carrier 32 has been described according to the arrangement shown as one example, any combination or arrangement may be used and is hereby contemplated for use in order to fit at least partially within cover 28 and facilitate connection between selector 34 and first ratchet member 36 and second ratchet member 38.

Selector 34: In the arrangement shown, as one example, system 10 includes selector 34. Selector 34 is formed of any suitable size, shape, and design and is configured to facilitate the selective movement of first ratchet member 36 and/or second ratchet member 38 between engaged position and disengaged position. In this arrangement, as one example, when selector 34 is positioned such that first ratchet member 36 and/or second ratchet member 38 is in the engaged position, first ratchet member 36 and/or second ratchet member 38 engages beaded chain 26 to facilitate movement of beaded chain 26. In the arrangement shown, as one example, selector 34 functions similar to a lever, rotating about a center axis. In the arrangement shown, as one example, selector 34 includes a main body 120, an engagement member 130, and arms 132.

In the arrangement shown, as one example, selector 34 includes a main body 120. Main body 120 is formed of any suitable size, shape, and design and is configured to provide a surface for a user to engage with in order to operate selector 34. In the arrangement shown, as one example, main body 120 has an upper end 122, a lower end 124, a front surface 126, a rear surface 128 and opposing right and left sides 129 (or simply “sides 129”). In the arrangement shown, as one example, the main body 120 of selector 34 is a generally convex curved member, with upper end 122 and lower end 124 which are generally positioned outward from the midpoint between the top and bottom of main body 120. In the arrangement shown, as one example, the front surface 126 of main body 120 of selector 34 is positioned on the outward side of front plate 56 so it can be engaged and operated by a user. In the arrangement shown, as one example, the main body 120 of selector 34 extends through slot 70 of front plate 56 and slot 86 of intermediate plate 58 such that the rear surface 128 of main body 120 of selector 34 is positioned at least partially between intermediate plate 58 and rear plate 60.

In the arrangement shown, as one example, selector 34 includes an engagement member 130. Engagement member 130 is formed of any suitable size, shape, and design and is configured to facilitate operable engagement between selector 34 and rear plate 60. In the arrangement shown, as one example, engagement member 130 is a generally cylindrical member which extends a distance outward from each of the opposing sides 129 of main body 120. In the arrangement shown, as one example, engagement member 130 is configured to be inserted into the open center 116 between sidewalls 114 of the engagement members 110 of rear plate 60. In the arrangement shown, as one example, when engagement member 130 is inserted into the open center 116, sidewalls 114 hold engagement member 130 in secured engagement with rear plate 60 while also allowing engagement member 130 of selector 34 to rotate about its center axis in order to facilitate operation of selector 34.

In the arrangement shown, as one example, selector 34 includes arms 132. Arms 132 are formed of any suitable size, shape, and design and are configured to help facilitate the movement of first ratchet member 36 and second ratchet member 38 between the engaged and disengaged positions. In the arrangement shown, as one example, there are two arms 132, with one arm 132 located near the upper end 122 of main body 120, and one arm 132 located near the lower end 124 of main body 120. In the arrangement shown, as one example, arms 132 are generally cylindrical in shape and extend a distance outward from the rear surface 128 of main body 120.

In the arrangement shown, as one example, arms 132 extend outward from rear surface 128 in a non-linear fashion and end at outer portion 134. Outer portion 134 is formed of any suitable size, shape, and design and is configured to selectively contact first ratchet member 36 and second ratchet member 38. In the arrangement shown, as one example, outer portion 134 is a generally oval member at the end of arms 132. In the arrangement shown, as one example, the non-linear extension of arms 132 and the cylindrical shape of outer portion 134 are advantageous because they allow outer portion 134 to make contact with first ratchet member 36 and/or second ratchet member 38 only when desired.

In the arrangement shown, as one example, selector 34 works as a lever rotating about a center axis formed by engagement member 130. In the arrangement shown, as one example, when a user desires to move selector 34, the user will push inward on either the upper end 122 or the lower end 124 of selector 34. In the arrangement shown, as one example, when the upper end 122 is pushed inward, then the lower end 124 will move outward, and when the lower end 124 is pushed inward, the upper end 122 will move outward. In the arrangement shown, as one example, as the upper end 122 is pushed inward, the arm 132 located near the upper end 122 is also pushed inward and the lower end 124, as well as the arm 132 located near the lower end 124, are moved outward. In this example, with lower end 124 moved outward, the outer portion 134 of the arm 132 located near the lower end 124 of selector 34 will contact second ratchet member 38 and move second ratchet member 38 to the disengaged position. Further, in this example, with upper end 122 pushed inward, the outer portion 134 of the arm 132 located near the upper end 122 of selector 34 will be pushed inward to a position where neither outer portion 134 nor arm 132 is contacting first ratchet member 36 due to the non-linear extension of arm 132, and first ratchet member 36 will move to the engaged position due to biasing member 150.

Conversely, in the arrangement shown as one example, as the lower end 124 is pushed inward, the arm located near the lower end 124 is also pushed inward and the upper end 122, as well as the arm 132 located near the upper end 122, are moved outward. In this example, with upper end 122 moved outward, the outer portion 134 of the arm 132 located near the upper end 122 of selector 34 will contact first ratchet member 36 and move first ratchet member 36 to the disengaged position. Further, in this example, with lower end 124 pushed inward, the outer portion 134 of the arm 132 located near the lower end 124 of selector 34 will be pushed inward to a position where neither outer portion 134 nor arm 132 is contacting second ratchet member 38 due to the non-linear extension of arm 132, and second ratchet member 38 will move to the engaged position due to biasing member 164.

In the arrangement shown, as one example, when the upper end 122 of selector 34 is moved inward, which allows first ratchet member 36 to move to the engaged position, the movement of carrier 32 downward causes shade material 24 to move upward. Additionally, in the arrangement shown as one example, when the lower end 124 of selector 34 is moved inward, which allows second ratchet member 38 to move to the engaged position, the movement of carrier 32 downward causes shade material 24 to move downward. In this way, in the arrangement shown as one example, selector 34 allows system 10 to be used in order for a user to select whether shade material 24 will be moved upward or downward.

In an alternative arrangement shown, as one example, when the upper end 122 of selector 34 is moved inward, which allows first ratchet member 36 to move to the engaged position, the movement of carrier 32 downward causes shade material 24 to move downward as well. Additionally, in the arrangement shown as one example, when the lower end 124 of selector 34 is moved inward, which allows second ratchet member 38 to move to the engaged position, the movement of carrier 32 downward causes shade material 24 to move upward.

While selector 34 has been described according to the arrangement shown as one example, any combination or arrangement may be used and is hereby contemplated for use in order to facilitate movement of first ratchet member 36 and/or second ratchet member 38 between the engaged and disengaged positions. In an alternative arrangement, shown as one example, selector 34 is a generally elongated member configured to move first ratchet member 36 and/or second ratchet member 38 between the engaged position and the disengaged position when selector 34 is moved from side to side. In various other alternative arrangements, as examples, selector 34 may utilize any other methods and/or means to move first ratchet member 36 and/or second ratchet member 38 between the engaged and disengaged positions including but not limited to switches, knobs, handles, buttons, levers, pulleys, links, gears, and/or any other method or means for actuation of first ratchet member 36 and second ratchet member 38. As yet another alternative, shown as one example, a first string may be pulled to facilitate movement of first ratchet member 36 between the engaged and disengaged positions and a second string may be pulled to facilitate movement of the second ratchet member 38 between the engaged and disengaged positions. Therefore, it is hereby contemplated that, although selector 34 has been shown and described according to the arrangements shown as examples, any other mechanisms may be used to cause first ratchet member 36 and/or second ratchet member 38 to engage beaded chain 26.

First Ratchet Member 36 and Second Ratchet Member 38: In the arrangement shown, as one example, actuator mechanism 30 includes first ratchet member 36 and second ratchet member 38. First ratchet member 36 and second ratchet member 38 are formed of any suitable size, shape, and design and are configured to facilitate engagement with beaded chain 26 of window shade system 22. In the arrangement shown, as one example, first ratchet member 36 and second ratchet member 38 are configured to move between an engaged position and a disengaged position. In the arrangement shown, as one example, when either first ratchet member 36 or second ratchet member 38 is in the engaged position, first ratchet member 36 or second ratchet member 38 engages beaded chain 26 to facilitate movement of beaded chain 26 as actuator mechanism 30 is moved by a user. In the arrangement shown, as one example, when in the engaged position, first ratchet member 36 or second ratchet member 38 are configured to move beaded chain 26 downward when actuator mechanism 30 is moved downward while permitting actuator mechanism 30 to be moved upward without moving beaded chain 26 upward.

In an alternative arrangement, as one example, actuator mechanism 30 may be moved up to cause shade material 24 to be moved up. That is, in an alternative arrangement, as one example, when in the engaged position first ratchet member 36 is configured to move beaded chain 26 downward when actuator mechanism 30 is moved downward thereby lowing shade material 22, while also permitting actuator mechanism 30 to be moved upward without moving beaded chain 26 upward. Also in this alternative arrangement as one example, when in the engaged position second ratchet member 38 is configured to move beaded chain 26 upward when actuator mechanism 30 is moved upward thereby raising shade material 22, while also permitting actuator mechanism 30 to be moved downward without moving beaded chain 26 downward.

In the arrangement shown, as one example, either first ratchet member 36 or second ratchet member 38 is in the engaged position while the other is in the disengaged position. Said another way, in the arrangement shown as one example, one of first ratchet member 36 or second ratchet member 38 is in the engaged position at any given time and there is no time when first ratchet member 36 and second ratchet member 38 are both in the engaged position or both in the disengaged position. However, it is hereby contemplated that in various other arrangements, there may be ways for first ratchet member 36 and second ratchet member 38 to both be in the engaged position, or both be in the disengaged position, while still allowing for proper movement of beaded chain 26 and use of actuator mechanism 30.

In the arrangement shown, as one example, first ratchet member 36 includes a body 140 with a front surface 142, a rear surface (not shown), an outer edge 144, protrusions 146, and an opening 148. In the arrangement shown, as one example, first ratchet member 36 also includes a biasing member 150 and connection end 152. In the arrangement shown, as one example, first ratchet member 36 and second ratchet member 38 are mirrored members. That is, first ratchet member 36 and second ratchet member 38 contain the same components, but first ratchet member 36 and second ratchet member 38 are oriented differently such that first ratchet member 36 engages a first portion of beaded chain 26 near one side 20 of system 10 and second ratchet member 38 engages a second portion of beaded chain 26 near the other side 20 of system 10. In the arrangement shown, as one example, second ratchet member 38 includes a body 154 with a front surface 156, a rear surface (not shown), an outer edge 158, protrusions 160, and an opening 162. In the arrangement shown, as one example, first ratchet member 36 also includes a biasing member 164 and connection end 166.

Body 140 of First Ratchet Member 36/Body 154 of Second Ratchet Member 38: In the arrangement shown, as one example, front surface 142 of first ratchet member 36 and front surface 156 of second ratchet member 38 are generally planar members. In the arrangement shown, as one example, the rear surfaces of each of body 140 and body 154 are also generally planar members which extend in approximate parallel planar spaced relation to front surface 142 and front surface 156, respectively. In the arrangement shown, as one example, body 140 of first ratchet member 36 also includes outer edge 144 which is approximately perpendicular to front surface 142 and the rear surface of body 140 and extends a distance past the rear surface of body 140. Likewise, in the arrangement shown, as one example, body 154 of second ratchet member 38 includes outer edge 158 which is approximately perpendicular to front surface 156 and the rear surface of body 154 and extends a distance past the rear surface of body 154.

Protrusions 146 of First Ratchet Member 36/Protrusions 160 of Second Ratchet Member 38: In the arrangement shown, as one example, first ratchet member 36 includes protrusions 146 and second ratchet member 38 include protrusions 160. Protrusions 146 are formed of any suitable size, shape, and design and are configured to facilitate engagement between first ratchet member 36 and intermediate plate 58 and rear plate 60. Protrusions 160 are formed of any suitable size, shape, and design and are configured to facilitate connection between second ratchet member 38 and intermediate plate 58 and rear plate 60. In the arrangement shown, as one example, protrusions 146 extend outward a distance from front surface 142 of body 140 in order to facilitate engagement between first ratchet member 36 and intermediate plate 58, and protrusions 146 also extend outward a distance from the rear surface of body 140 in order to facilitate engagement between first ratchet member 36 and rear plate 60. Similarly, in the arrangement shown as one example, protrusions 160 extend outward a distance from front surface 156 of body 154 in order to facilitate engagement between second ratchet member 38 and intermediate plate 58, and protrusions 160 also extend outward a distance from the rear surface of body 154 in order to facilitate engagement between second ratchet member 38 and rear plate 60.

In the arrangement shown, as one example, protrusions 146 and protrusions 160 are generally cylindrical in shape and are configured to be received within recesses 90 of intermediate plate 58 and recesses 108 of rear plate 60. In the arrangement shown, as one example, when protrusions 146 and protrusions 160 are received within recesses 90 of intermediate plate 58 and recesses 108 of rear plate 60, protrusions 146 and protrusions 160 are held therein yet still allowed to rotate about the center axis of protrusions 146 and protrusions 160, respectively, in order to allow first ratchet member 36 and second ratchet member 38 to move between an engaged position and a disengaged position. That is, when first ratchet member 36 and second ratchet member 38 are moved between an engaged position and a disengaged position, first ratchet member 36 and second ratchet member 38 will rotate about the center axis of protrusions 146 and protrusions 160, respectively, even when protrusions 146 and protrusions 160 are within recesses 90 and recesses 108.

Opening 148 of Body 140/Opening 162 of Body 154: In the arrangement shown, as one example, body 140 of first ratchet member 36 includes opening 148 and body 154 of second ratchet member 38 includes opening 162. Opening 148 is formed of any suitable size, shape, and design and is configured to allow for selective engagement between first ratchet member 36 and outer portion 134 of an arm 132 of selector 34. Likewise, opening 162 is formed of any suitable size, shape, and design and is configured to allow for selective engagement between second ratchet member 38 and outer portion 134 of an arm 132 of selector 34. In the arrangement shown, as one example, opening 148 and opening 162 are amorphous, having various straight and curved surfaces. In the arrangement shown, as one example, one of the surfaces of opening 148 and opening 162 is configured to provide a surface which outer portion 134 of arms 132 of selector 34 will contact in order to move first ratchet member 36 and/or second ratchet member 38 to a disengaged portion. That is, in the arrangement shown as one example, outer portion 134 of arms 132 of selector 34 is configured to contact one of the surfaces of opening 148 of first ratchet member 36 and one of the surfaces of opening 162 of second ratchet member 38 when such arm 132 is moved outward, thereby forcing first ratchet member 36 or second ratchet member 38 to a disengaged position.

Biasing Member 150 and Biasing Member 164: In the arrangement shown, as one example, first ratchet member 36 includes biasing member 150 and second ratchet member 38 includes biasing member 164. Biasing member 150 is formed of any suitable size, shape, and design and is configured to facilitate movement of first ratchet member 36 to an engaged position when first ratchet member 36 is not forced to the disengaged position by selector 34. Similarly, biasing member 164 is formed of any suitable size, shape, and design and is configured to facilitate movement of second ratchet member 38 to an engaged position when second ratchet member 38 is not forced to the disengaged position by selector 34. In the arrangement shown, as one example, biasing member 150 and biasing member 164 are connected to rear plate 60. In the arrangement shown, as one example, biasing member 150 and biasing member 164 are magnets. In the arrangement shown, as one example, a portion of the outer edge 144 of first ratchet member 36 is formed of a metallic and magnetic member which is drawn into contact with the magnet of biasing member 150 when first ratchet member 36 is not forced to a disengaged position by selector 34. In the arrangement shown, as one example, a portion of the outer edge 158 of second ratchet member 38 is also formed of a metallic and magnetic member which is drawn into contact with the magnet of biasing member 164 when second ratchet member 38 is not forced to a disengaged position by selector 34. While biasing member 150 and biasing member 164 are magnets in the arrangement shown, as one example, any other mechanism or member configured to act as a biasing member may be used as biasing member 150 and biasing member 164, including, but not limited to various different types of springs, levers, hydraulic members, electronically controlled members, or any other type of biasing member.

Connection End 152 of First Ratchet Member 36 and Connection End 166 of Second Ratchet Member 38: In the arrangement shown, as one example, first ratchet member 36 includes connection end 152 and second ratchet member 38 includes connection end 166. Connection end 152 and connection end 166 are formed of any suitable size, shape, and design and are configured to engage beaded chain 26 and pull beaded chain 26 when carrier 32 is moved downward, and move over beaded chain 26 when carrier 32 is moved upward. In the arrangement shown, as one example, connection end 152 extends outward from body 140 of first ratchet member 36. Likewise, in the arrangement shown, as one example, connection end 166 extends outward from body 154 of second ratchet member 38.

In the arrangement shown, as one example, at their outer ends, connection end 152 and connection end 166 include a recessed portion and an angled portion. The recessed portion is on the upper side of the outer end and the angled portion is on the lower side of the outer end of connection end 152 and connection end 166. In the arrangement shown, as one example, the recessed portion is a concave recess with a slight hook and is shaped to receive a bead from beaded chain 26 and hold the bead or ball therein. In the arrangement shown, as one example, the angled portion of connection end 152 and connection end 166 angles back and down, toward the inner portion of connection end 152 and connection end 166. However, any other shape or configuration of connection end 152 and connection end 166 may be used in order to grab a beaded chain 26.

In the arrangement shown, as one example, when the upper end 122 of main body 120 of selector 34 is pushed inward, outer portion 134 of arms 132 of selector 34 is not in contact with first ratchet member 36 and first ratchet member 36 is drawn to the engaged position by biasing member 150. When first ratchet member 36 is in the engaged position, the connection end 152 of first ratchet member 36 is forced outward and into contact with a portion of beaded chain 26. Similarly, in the arrangement shown as one example, when the lower end 124 of main body 120 of selector 34 is pushed inward, outer portion 134 of arms 132 of selector 34 is not in contact with second ratchet member 38 and second ratchet member 38 is drawn to the engaged position by biasing member 164. When second ratchet member 38 is in the engaged position, the connection end 166 of second ratchet member 38 is forced outward and into contact with a portion of beaded chain 26. When either connection end 152 or connection end 166 is forced outward and into contact with a portion of beaded chain 26, connection end 152 or connection end 166 will hold that portion of beaded chain 26 therein. In this position, any movement of carrier 32 downward will move connection end 152 or connection end 166 downward, which in turn will cause the portion of beaded chain 26 engaged with either connection end 152 or connection end 166 to move down as well, and this will cause shade material 24 to be raised or lowered.

In the arrangement shown, as one example, when a portion of beaded chain 26 is held within connection end 152 or connection end 166 and carrier 32 is moved up, the angled portion of connection end 152 or connection end 166 moves the beads of beaded chain 26 such that they do not become captured within the recessed portion of connection end 152 or connection end 166. In this way, in the arrangement shown as one example, first ratchet member 36 and second ratchet member 38 are able to be moved over beaded chain 26 when first ratchet member 36 or second ratchet member 38 are in the engaged position, which allows a user to repeatedly raise and lower carrier 32 without having to disengage connection end 152 or connection end 166 from beaded chain 26.

While first ratchet member 36 and second ratchet member 38 and their various components have been described according to the arrangement shown as one example, any combination or arrangement may be used and is hereby contemplated for use in order to engage beaded chain 26 and cause a portion of beaded chain 26 to move downward, thereby facilitating movement of shade material 24.

In Operation:

In the arrangement shown, as one example, carrier 32 rests at least partially within cover 28 and the front surface 126 of main body 120 of selector 34 is accessible from the front side 50 of cover 28. In the arrangement shown, as one example, cover 28 and actuator mechanism 30 are placed over a beaded chain 26 of window shade system 22 such that the beaded chain 26 rests at least partially within semi-enclosed channels 55 of cover 28 and at least partially within carrier 32. Shade material 24 may be either in an open position or a closed position and a user determines whether they want to raise or lower shade material 24. For purposes of illustration, and not limitation, first ratchet member 36 is engaged when desiring to raise shade material 24 and is positioned such that connection end 152 of first ratchet member 36 will be near the right end 20 of system 10 when first ratchet member 36 is in the engaged position. Likewise, for purposes of illustration and not limitation, second ratchet member 38 is engaged when desiring to lower shade material 24 and is positioned such that connection end 166 of second ratchet member 38 will be near the left end 20 of system 10.

In this arrangement, if the user desires to lower shade material 24, the user will push the lower end 124 of selector 34 inward. When the lower end 124 of selector 34 is moved inward, the arm 132 near the lower end 124 of selector 34 will also be moved inward and the outer portion 134 of such arm 132 near the lower end 124 of selector 34 will disengage from a surface created by opening 162 in second ratchet member 38. With outer portion 134 of such arm 132 disengaged from second ratchet member 38, second ratchet member 38 will be forced to the engaged position by biasing member 164. With second ratchet member 38 in the engaged position, connection end 166 of second ratchet member 38 will engage a portion of beaded chain 26. Also in this arrangement, as one example, when the lower end 124 of selector 34 is pushed inward, the upper end 122 of selector 34 will move outward and the arm 132 near the upper end 122 of selector 34 will also move outward. As the arm 132 near the upper end 122 of selector 34 moves outward, the outer portion 134 of such arm 132 contacts one of the surfaces created by opening 148 in body 140 of first ratchet member 36. When the outer portion 134 of such arm 132 contacts one of the surfaces created by opening 148, first ratchet member 36 is moved from the engaged position to the disengaged position. When in the disengaged position the connection end 152 of first ratchet member 36 will not engage any portion of beaded chain 26. With second ratchet member 38 in the engaged position and first ratchet member 36 in the disengaged position, when carrier 32 is moved downward, connection end 166 will move downward along with the portion of beaded chain 26 engaged with connection end 166. In the arrangement shown, as one example, when the portion of beaded chain 26 engaged with connection end 166 moves down, shade material 24 will be lowered.

If the user desires to further lower shade material 24, the user can simply raise carrier 32 and the angled portion of connection end 166 will cause connection end 166 to move over the beads of beaded chain 26. With carrier 32 raised, the user is able to pull down on carrier 32 again, which will cause a portion of beaded chain 26 to be held within connection end 166, causing beaded chain 26 to move downward and shade material 24 to be lowered further. In this way, a user can repeatedly raise and lower carrier 32 within a limited vertical range while lowering shade material 24 a large amount.

In the arrangement shown, as one example, if the user desires to raise shade material 24, the user will push the upper end 122 of selector 34 inward. When the upper end 122 of selector 34 is moved inward, the arm 132 near the upper end 122 of selector 34 will also be moved inward and the outer portion 134 of such arm 132 near the upper end 122 of selector 34 will disengage from a surface created by opening 148 in first ratchet member 36. With outer portion 134 of such arm 132 disengaged from first ratchet member 36, first ratchet member 36 will be forced to the engaged position by biasing member 150. With first ratchet member 36 in the engaged position, connection end 152 of first ratchet member 36 will engage a portion of beaded chain 26. Also in this arrangement, as one example, when the upper end 122 of selector 34 is pushed inward, the lower end 124 of selector 34 will move outward and the arm 132 near the lower end 124 of selector 34 will also move outward. As the arm 132 near the lower end 124 of selector 34 moves outward, the outer portion 134 of such arm 132 contacts one of the surfaces created by opening 162 in body 154 of second ratchet member 38. When the outer portion 134 of such arm 132 contacts one of the surfaces created by opening 162, second ratchet member 38 is moved from the engaged position to the disengaged position. When in the disengaged position the connection end 166 of second ratchet member 38 will not engage any portion of beaded chain 26. With first ratchet member 36 in the engaged position and second ratchet member 38 in the disengaged position, when carrier 32 is moved downward, connection end 152 will move downward along with the portion of beaded chain 26 engaged with connection end 152. In the arrangement shown, as one example, when the portion of beaded chain 26 engaged with connection end 152 moves down, shade material 24 will be raised.

If the user desires to further raise shade material 24, the user can simply raise carrier 32 and the angled portion of connection end 152 will cause connection end 152 to move over the beads of beaded chain 26. With carrier 32 raised, the user is able to pull down on carrier 32 again, which will cause a portion of beaded chain 26 to be held within connection end 152, causing beaded chain 26 to move downward and shade material 24 to be lowered further. In this way, a user can repeatedly raise and lower carrier 32 within a limited vertical range while lowering shade material 24 a large amount.

### Alternative Arrangements:

Alternative Arrangement 1:

With reference to the figures, various alternative arrangements of system 10 are shown and presented. The alternative arrangement shown are similar to the arrangements shown and described above and as such, the disclosure above applies to the alternative arrangements shown and described below unless stated specifically below. The primary difference presented in the alternative arrangements are the carrier 232, first ratchet member 236, and second ratchet member 238. In an alternative arrangement shown, as one example, system 10 includes actuator 230 having carrier 232, selector 234, first ratchet member 236, and second ratchet member 238.

Carrier 232: In an alternative arrangement shown, as one example, actuator mechanism 230 includes carrier 232. Carrier 232 is formed of any suitable size, shape, and design and is configured to fit at least partially within cover 28 and facilitate connection between selector 234 and first ratchet member 236 and second ratchet member 238. In the arrangement shown, as one example, carrier has a top end 256, a bottom end 258, a front side 260, a back side 262, and left and right ends 264 (or simply “ends 264”). In the arrangement shown, as one example, carrier 232 includes curved slots 266 and lateral slots 268.

In the arrangement shown, as one example, when viewed from back side 262, carrier 232 is generally rectangular in shape, with top end 256 and bottom end 258 extending in approximate parallel planar spaced relation, and with ends 264 extending in approximate parallel planar spaced relation. In the arrangement shown, as one example, when viewed from top end 256 or bottom end 258, carrier 232 includes semi-enclosed channels 270 on each end 264, which are connected by a planar surface 265 extending between each semi-enclosed channel 270 on the back side 262 or carrier 232. In the arrangement shown, as one example, when viewed from top end 256 or bottom end 258, there is an open area between the semi-enclosed channels 270 on each end 264. In the arrangement shown, as one example, semi-enclosed channels 270 include interior surfaces 272. Interior surfaces 272 are generally smooth surfaces which allow for beaded chain 26 to slide along interior surfaces 272. In the arrangement shown, as one example, beaded chain 26 is positioned within the semi-enclosed channels 270 of carrier 232. In the arrangement shown, as one example, semi-enclosed channels 270 of carrier 232 are held within semi-enclosed channels 55 of cover 28. In this way, beaded chain 26 is held within both semi-enclosed channels 270 of carrier 232 and semi-enclosed channels 55 of cover 28.

In the arrangement shown, as one example, the planar surface 265 extending between each semi-enclosed channel 270 includes curved slots 266. Curved slots 266 are formed of any suitable size, shape, and design and is configured to guide first ratchet member 236 and second ratchet member 238 when engaged by selector 234 so as to cause the engaged first ratchet member 236 or second ratchet member 238 to thereby engage beaded chain 26. In the arrangement shown, as one example, curved slots 266 extend from the front side 260 to the back side 262 of carrier 232. In the arrangement shown, as one example, curved slots 266 are generally convex, starting at an upward position towards the middle of carrier 232 and extending downward and towards each end 264 of carrier 232 in a curved manner. In the arrangement shown, as one example, there is a curved slot 266 on each side and spaced equidistance from the mid-point between end 264 and end 264 of carrier 232.

In the arrangement shown, as one example, the planar surface 265 extending between each semi-enclosed channel 270 includes lateral slots 268. Lateral slots 268 are formed of any suitable size, shape, and design, and are configured to facilitate operable connection of selector 234 to carrier 232 and side to side movement of selector 234 to facilitate selectable engagement of selector 234 with first ratchet member 236 and second ratchet member 238. In the arrangement shown, as one example, lateral slots 268 extend from the front side 260 to the back side 262 of carrier 232. In the arrangement shown, as one example, lateral slots 268 are generally in the shape of an elongated oval, with a length extending from near one semi-enclosed channel 270 to near the other semi-enclosed channel 270. In the arrangement shown, as one example, there are three lateral slots 268 on carrier 232, however any other number of lateral slots 268 can be used and are hereby contemplated for use. In one or more arrangements, selector 234 includes axles 274 which extend from selector 234 through lateral slots 268 to the back side 262 of carrier 232. In this way, lateral slots 268 facilitate connection between selector 234 and carrier 232, while permitting selector 234 to be moved side to side relative to carrier 232.

In the arrangement shown, as one example, the planar surface 265 extending between each semi-enclosed channel 270 includes holes 267. Holes 267 are formed of any suitable size, shape, and design and are configured to facilitate the operable connection of linkage member 288 of first ratchet member 236 with carrier 232 and facilitate operable connection of linkage member 300 of second ratchet member 238 with carrier 232. In the arrangement shown, as one example, holes 267 are generally circular in shape and extend from the front side 260 to the back side 262 of carrier 232. In the arrangement shown, as one example, holes 267 are in or in near alignment vertically with the bottom of curved slots 266 and there is a hole 267 on each side and spaced equidistance from the mid-point between end 264 and end 264 of carrier 232.

While carrier 232 has been described according to the arrangement shown as one example, any combination or arrangement may be used and is hereby contemplated for use in order to fit at least partially within cover 28 and facilitate connection between selector 234 and first ratchet member 236 and second ratchet member 238.

Selector 234: In an alternative arrangement, as one example, actuator mechanism 230 includes selector 234. Selector 234 is formed of any suitable size, shape, and design and is configured to selectively move first ratchet member 236 and/or second ratchet member 238 between the engaged position and the disengaged position. In this alternative arrangement, when selector 234 moves first ratchet member 236 and/or second ratchet member 238 to the engaged position, first ratchet member 236 and/or second ratchet member 238 engage beaded chain 26 to facilitate movement of beaded chain 26.

In the arrangement shown, selector 234 is configured to move first ratchet member 236 and/or second ratchet member 238 between the engaged position and the disengaged position when selector 234 is moved from side to side. In this example arrangement selector 234 has a top end 276, a bottom end 278, a front side 280, a back side 282, left and right ends 284 (or simply “ends 284”), and a forward protrusion 286. Selector 234 may be formed of a single, unitary member that is formed in a manufacturing process such as molding, pressing, forming, additive manufacturing, machining, or the like to form a unitary and monolithic member. Alternatively, selector 234 may be formed of multiple pieces that are connected or assembled to one another such as through screwing, bonding, adhering, interlocking, friction fitting, or the like. In the arrangement shown, as one example, selector 234 is formed primarily of non-metallic materials. As examples, selector 234 may be formed of a plastic material, a composite material, a fiberglass material, or any other non-metallic material, and selector 234 may also be formed of a metallic material if desirable, such as stainless steel, chromium, aluminum, or any other metallic material.

In the arrangement shown, as one example, when viewed from front side 280, selector 234 is generally rectangular at top end 276 and extends downward from top end 276 in a generally rectangular manner for a length, before curving, in a convex manner, toward the middle of selector 234. In the arrangement shown, as one example, selector 234 includes forward protrusion 286. Forward protrusion 286 is formed of any suitable size, shape, and design and is configured to allow a user to move selector 234 from one position to another, thereby facilitating engagement with and movement of ratchet member 236 and second ratchet member 238.

In the arrangement shown, as one example, forward protrusion 286 extends from top end 276 to bottom end 278 of selector 234 and extends out from front side 280 of selector 234 and towards front side 16 of system 10. In this way, forward protrusion 286 extends outward from the open area between the semi-enclosed channels 55 of cover 28, thereby allowing a user to access forward protrusion 286 and selector 234.

While selector 324 has been described according to the arrangement shown as one example, any combination or arrangement may be used and is hereby contemplated for use in order to facilitate movement of first ratchet member 236 and/or second ratchet member 238 between the engaged and disengaged position. As one alternative, in various arrangements selector 234 may utilize various methods and/or means to move first ratchet member 236 and/or second ratchet member 238 between the engaged and disengaged positions including but not limited to switches, leavers, knobs, handles, buttons, levers, pulleys, links, gears, and/or any other method or means for actuation of first ratchet members 236 or second ratchet member 238. As one example, a first string may be pulled to facilitate movement of first ratchet member 236 between the engaged and disengaged position and a second string may be pulled to facilitate movement of the second ratchet member 238 between the engaged and disengaged position. Therefore, it is hereby contemplated that, although selector 234 has been shown and described according to the arrangement shown as one example, many other mechanisms may be used to cause first ratchet member 236 and/or second ratchet member 238 to engage beaded chain 26.

First Ratchet Member 236 and Second Ratchet Member 238: In an alternative arrangement shown, as one example, actuator mechanism 230 includes first ratchet member 236 and second ratchet member 238. First ratchet member 236 and second ratchet member 238 are formed of any suitable size, shape, and design and are configured to move between an engaged position and a disengaged position. In this example arrangement, when in an engaged position, first ratchet member 236 and second ratchet member 238 engage a portion of beaded chain 26 to facilitate movement of beaded chain 26 as actuator mechanism 230 is moved by a user. In this example arrangement, when in an engaged position, first ratchet member 236 and second ratchet member 238 are configured to move beaded chain 26 downward when actuator mechanism 230 is moved downward while permitting actuator mechanism 230 to be moved upward without moving beaded chain 26 upward. In this example arrangement, when in a disengaged position, first ratchet member 236 and second ratchet member 238 disengage from the beaded chain 26 so as to permit actuator mechanism 230 to be moved upward or downward without moving beaded chain 26.

In yet another alternative arrangement, as one example, when in the engaged position first ratchet member 236 is configured to move beaded chain 26 downward when actuator mechanism 230 is moved downward thereby lowing shade material 22, while also permitting actuator mechanism 230 to be moved upward without moving beaded chain 26 upward. Also in this alternative arrangement, when in the engaged position second ratchet member 238 is configured to move beaded chain 26 upward when actuator mechanism 230 is move upward thereby raising shade material 22, while also permitting actuator mechanism 230 to be moved downward without moving beaded chain 26 downward.

In an alternative arrangement shown, as one example, first ratchet member 236 includes a linkage member 288, a linkage spring 290, a first joint 292, a second joint 294, and a connection end 296. In the arrangement shown, as one example, second ratchet member 238 includes a linkage member 300, a linkage spring 302, a first joint 304, a second joint 306, and a connection end 308.

In the alternative arrangement shown, as one example, first ratchet member 236 includes first joint 292 and second ratchet member 238 includes first joint 304. First joint 292 and first joint 304 are formed of any suitable size, shape, and design and are configured to facilitate connection between first ratchet member 236 and carrier 232 and second ratchet member 238 and carrier 232. In the arrangement shown, as one example, first joint 292 and first joint 304 protrude out from linkage member 288 of first ratchet member 236 and linkage member 300 of second ratchet member 238, respectively, and are placed and held in a hole 267 of carrier 232. Said another way, first joint 292 of first ratchet member 236 is held within hole 267 on one side of the center of carrier 232 and first joint 304 of second ratchet member 238 is held within the hole 267 on the other side of the center of carrier 232. When first joint 292 and first joint 304 are positioned within a hole 267 of carrier 232, they are held in close and tight tolerances therein, thereby facilitating connection between first ratchet member 236 and carrier 232 and second ratchet member 238 and carrier 232.

In the arrangement shown, as one example, first ratchet member 236 includes linkage member 288 and second ratchet member 238 includes linkage member 300. Linkage member 288 is formed of any suitable size, shape, and design and is configured to connect first joint 292 with second joint 294 of first ratchet member 236. Likewise, linkage member 300 is formed of any suitable size, shape, and design and is configured to connect first joint 304 with second joint 306 of second ratchet member 238. In the arrangement shown, as one example, linkage member 288 and linkage member 300 are generally elongated ovals, with linkage member 288 of first ratchet member 236 extending a length between first joint 292 and second joint 294, and linkage member 300 of second ratchet member 238 extending a length between first joint 304 and second joint 306.

In the arrangement shown, as one example, first ratchet member 236 includes second joint 294 and second ratchet member 238 includes second joint 306. Second joint 294 is formed of any suitable size, shape, and design and is configured to facilitate movement of first ratchet member 236 between the engaged position and the disengaged position. Likewise, second joint 306 is formed of any suitable size, shape, and design and is configured to facilitate movement of second ratchet member 238 between the engaged position and the disengaged position. In the arrangement shown, as one example, second joint 294 protrudes outward in a cylindrical shape from first ratchet member 236 towards both front side 16 and back side 18 of system 10 and second joint 306 protrudes outward in a cylindrical shape from second ratchet member 238 towards both front side 16 and back side 18 of system 10. On the front side 16 of system 10, second joint 294 extends through connection end 296 of first ratchet member 236 and second joint 306 extends through connection end 308 of second ratchet member 238. On the back side 18 of system 10, second joint 294 extends through one curved slot 266 of carrier 232 and second joint 306 extends through the other curved slot 266 of carrier 232.

In the arrangement shown, as one example, when second joint 294 and second joint 306 are extended through a curved slot 266, second joint 294 and second joint 306 are allowed to freely slide or move within curved slots 266. When second joint 294 and second joint 306 extend through curved slots 266, they may be engaged and moved by selector 234. When second joint 294 or second joint 306 are originally inserted through curved slots 266, they rest at the top and inward portion curved slots 266, either resting against, or closely to, selector 234. When selector 234 moves either left or right, it makes contact with either second joint 294 or second joint 306 and forces them to slide within curved slots 266 toward the lower and outward portion of curved slots 266. When second joint 294 is moved toward the lower and outward portion of curved slot 266, it forces connection end 296 of first ratchet member 236 outward, causing it to pinch beaded chain 26 against the interior surface 272 of semi-enclosed channels 270 of carrier 232. Likewise, when second joint 306 is moved toward the lower and outward portion of curved slot 266, it forces connection end 308 of second ratchet member 238 outward, causing it to pinch beaded chain 26 against the interior surface 272 of semi-enclosed channels 270 of carrier 232.

In the arrangement shown, as one example, first ratchet member 236 includes a linkage spring 290 and second ratchet member 238 includes a linkage spring 302. Linkage spring 290 is formed of any suitable size, shape, and design and is configured to pull second joint 294 back to the upper and inward portion of curved slot 266, and thereby move first ratchet member 236 to the disengaged position, when selector 234 is no longer engaging second joint 294 of first ratchet member 236. Likewise, linkage spring 302 is formed of any suitable size, shape, and design and is configured to pull second joint 306 back to the upper and inward portion of curved slot 266, and thereby move second ratchet member 238 to the disengaged position, when selector 234 is no longer engaging second joint 306 of first ratchet member 236. In the arrangement shown, as one example, linkage spring 290 and linkage spring 302 are torsion springs. In the arrangement shown, as one example, one end of linkage spring 290 and/or linkage spring 302 is engaged with connection end 296 or connection end 308 on the front side 16 of system 10 and extends toward back side 18 of system 10 and around second joint 294 or second joint 306, then extends along linkage member 288 or linkage member 300, before going through to the back side of linkage member 288 or linkage member 300 and wrapping around first joint 292 or first joint 304, then extending along linkage member 288 or linkage member 300 again before coming to an end near second joint 294 or second joint 306 on the back side 18 of system 10. While linkage spring 290 and linkage spring 302 are described according to the arrangement shown as one example, other type of springs and/or other mechanisms may be used to move first ratchet member 236 and second ratchet member 238 to the disengaged positions.

In an alternative arrangement shown, as one example, first ratchet member 236 includes connection end 296 and second ratchet member 238 includes connection end 308. Connection end 296 and connection end 308 are formed of any suitable size, shape, and design and are configured to engage beaded chain 26 and pull beaded chain 26 when carrier 232 is moved downward, and move over beaded chain 26 when carrier 232 is moved upward. In the arrangement shown, as one example, connection end 296 connects to linkage member 288 of first ratchet member 236 through second joint 294. Likewise, in the arrangement shown, as one example, connection end 308 connects to linkage member 300 of second ratchet member 238 through second joint 306. In the arrangement shown, as one example, connection end 296 and connection end 308 extend out from second joint 294 and second joint 306, respectively, toward ends 20 of system 10.

In the arrangement shown, as one example, at their outer ends, connection end 296 and connection end 308 include a recessed portion and an angled portion. The recessed portion is on the upper side of the outer end and the angled portion is on the lower side of the outer end of connection end 296 and connection end 308. In the arrangement shown, as one example, the recessed portion is a concave, circular recess with a slight hook and is shaped to receive a bead or ball from beaded chain 26 and hold the bead or ball therein. In the arrangement shown, as one example, the angled portion of connection end 296 and connection end 308 angles back and down, toward the inner portion of connection end 296 and connection end 308.

When second joint 294 or second joint 306 are moved toward the lower and outward portion of curved slots 266, connection end 296 or connection end 308 moved outward, thereby moving first ratchet member 236 or second ratchet member 238 to the engaged position and pinching beaded chain 26 against interior surface 272 of the semi-enclosed channels 270 of carrier 232. When beaded chain 26 is pinched against interior surface 272, connection end 296 or connection end 308 receives and holds a bead from beaded chain 26 within the recessed portion. With the bead being held within the recessed portion of connection end 296 or connection end 308, movement of carrier 232 downward causes connection end 296 and connection end 308 to be moved downward and causing beaded chain 26 to be pulled downward, thereby facilitating the raising or lowering of shade material 24. When beaded chain 26 is pinched against interior surface 272 and a bead from beaded chain 26 is engaged with connection end 296 or connection end 308 and carrier 232 is moved up, the angled portion of connection end 296 or connection end 308 moves over the beads of beaded chain 26. In this way, when first ratchet member 236 and second ratchet member 238 are moved to the engaged position by selector 234, and connection end 296 or connection end 308 are moved into engagement with beaded chain 26, connection end 296 and connection end 308 may be raised and lowered repeatedly without having to disengage connection end 296 or connection end 308 from beaded chain 26.

While first ratchet member 236 and second ratchet member 238 have been described according to the alternative arrangement shown as one example, any combination or arrangement may be used and is hereby contemplated for use in order to engage beaded chain 26 and cause a portion of beaded chain 26 to move downward, thereby facilitating movement of shade material 24.

Alternative Arrangement 2:

In another alternative arrangement, rather than the user being required to raise the carrier 232 to continue raising or lowering shade material 24, the system 10 can include a retractable assembly 310. While the user moves carrier 232 downward, the retractable assembly 310 is expanded beyond its resting position. Once the user is finished moving carrier 232 downward, the user releases carrier 232 and the retractable assembly 310 contracts back to its resting position, thereby pulling carrier 232 back up. The user can then move carrier 232 down again, thereby continuing to raise or lower shade material 24 further. In this way, the user simply lowers carrier 232, releases it, and lowers carrier 232 again, without having to manually move carrier 232 upward.

Alternative Arrangement 3:

In another alternative arrangement, rather than having selector 234, strings can be used to facilitate engagement between first ratchet member 236 and beaded chain 26 or second ratchet member 238 and beaded chain 26. In this arrangement, a first string is attached to first ratchet member 236 and a second string is attached to second ratchet member 238. When a user desires to raise or lower shade material 24, the user will pull down on either the first string or the second string. When the first string or the second string is pulled down, connection end 296 or connection end 308 will be forced outward. Once connection end 296 or connection end 308 is forced outward, this arrangement functions the same as various other arrangements described herein.

Alternative Arrangement 4:

In another alternative arrangement, an actuator system 10 is presented that is narrower than various arrangements described herein. In this alternative arrangement, carrier 232 does not include curved slots 266 or lateral slots 268. Rather, carrier 232 includes a first vertical slot 316 and a first H-slot 318, and a second vertical slot 320 and a second H-slot 322. Additionally, carrier 232 includes a rubber layer 323 on interior surface 272 of semi-enclosed channels 270 in this alternative arrangement. Rather than having first ratchet member 236 and second ratchet member 238, this alternative arrangement has two mating ramp sets 324. Each mating ramp set 324 includes a vertical ramp 326 and a horizontal ramp 328. In the arrangement shown, as one example, vertical ramp 326 and horizontal ramp 328 are generally in the shape of a triangle when viewed from front side 16 or back side 18 of system 10, with the hypotenuse of the vertical ramp 326 adjacent the hypotenuse of the horizontal ramp 328. In the arrangement shown, as one example, when viewed from ends 20 vertical ramp 326 and horizontal ramp 328 are rectangular in shape. In the arrangement shown, as one example, horizontal ramp 328 includes a rubber layer 330 on its outward edge nearest beaded chain 26 and ends 20 of system 10. Finally, each mating ramp set 324 includes a string 332 connected to vertical ramp 326.

In the arrangement shown, as one example, the vertical ramp 326 of the first mating ramp set 324 has an axle 334 which extends through the first vertical slot 316 of carrier 232 and the horizontal ramp 328 of the first mating ramp set 324 has an axle 336 which extends through the first H-slot 318 of carrier 232. Likewise, the vertical ramp 326 of the second mating ramp set 324 has an axle 334 which extends through the second vertical slot 320 of carrier 232 and the horizontal ramp of the second mating ramp set 324 has an axle 336 which extends through the second H-slot 322 of carrier 232.

In operation, when a user desires to raise or lower shade material 24, the user will pull downward on string 332 for the mating ramp set 324 which corresponds with the desired the raising or lowering of shade material 24. When the user pulls string 332, axle 334 of vertical ramp 326 moves downward within the first vertical slot 316 or second vertical slot 320 and vertical ramp 326 moves downward as well. As vertical ramp 326 moves downward, the hypotenuse of vertical ramp 326 slides down the hypotenuse of horizontal ramp 328 and causes horizontal ramp 328 to extend outward toward an end 20, and axle 336 slides within first H-slot 318 or second H-slot 322 toward an end 20. When horizontal ramp 328 is moved outward, the rubber layer 330 of horizontal ramp 328 contacts beaded chain 26 and causes beaded chain 26 to be pinched between rubber layer 330 of horizontal ramp 328 and rubber layer 323 on the interior surface 272 of semi-enclosed channel 270 of carrier 232. Once beaded chain 26 is pinched between rubber layer 330 and rubber layer 323, carrier 232 is moved downward, thereby moving the beaded chain 26 downward and raising or lowering shade material 24. This alternative arrangement may also be used with retractable assembly 310, which functions the same as previously described herein.

From the above discussion it will be appreciated that the system 10 presented herein improves upon the state of the art. Specifically, in one or more arrangements, system 10 is safe; complies with the restrictions or bans, or proposed restrictions or bans, on the use of beaded chains with window shade systems; is relatively easy to install; is cost friendly to install; can be installed quickly and efficiently; is easy to install correctly; is easy to use; is cost friendly to manufacture; is easy to manufacture; is relatively lightweight; is aesthetically appealing; is robust; is relatively inexpensive; is not easily susceptible to wear and tear; has a long useful life; and/or is efficient to use.

What is claimed:

1. An actuator system for facilitating movement of shade material of a window shade system between an open position and a closed position, the window shade system having a beaded chain, the actuator system comprising:
a cover;
wherein the beaded chain is at least partially positioned within the cover;
an actuator mechanism;
the actuator mechanism having a carrier;
the actuator mechanism having a first ratchet member;
the actuator mechanism having a second ratchet member;
the actuator mechanism having a selector; and
wherein movement of the selector facilitates engagement of one of the first ratchet member or the second ratchet member with the beaded chain so as to facilitate raising or lowering of the shade material.

2. The actuator system of claim 1 wherein when the selector facilitates engagement of the first ratchet member with the beaded chain, the beaded chain is held between a connection end of the first ratchet member and an interior surface of the carrier.

3. The actuator system of claim 1 wherein when the selector facilitates engagement of the second ratchet member with the beaded chain, the beaded chain is held between a connection end of the second ratchet member and an interior surface of the carrier.

4. The actuator system of claim 1 wherein when the selector facilitates engagement of the first ratchet member with the beaded chain and the carrier is moved downward, the portion of the beaded chain which is engaged with the first ratchet member is forced downward thereby raising or lowering the shade material.

5. The actuator system of claim 1 wherein when the selector facilitates engagement of the second ratchet member with the beaded chain and the carrier is moved downward, the portion of the beaded chain which is engaged with the second ratchet member is forced downward thereby raising or lowering the shade material.

6. The actuator system of claim 1 wherein when the selector facilitates engagement of the first ratchet member with the beaded chain, the first ratchet member stays engaged with the beaded chain until the selector disengages the first ratchet member from the beaded chain.

7. The actuator system of claim 1 wherein when the selector facilitates engagement of the second ratchet member with the beaded chain, the second ratchet member stays engaged with the beaded chain until the selector disengages the second ratchet member from the beaded chain.

8. The actuator system of claim 1 wherein when the first ratchet member is engaged with the beaded chain and the carrier is moved upward, the first ratchet member moves over the beaded chain.

9. The actuator system of claim 1 wherein when the second ratchet member is engaged with the beaded chain and the carrier is moved upward, the second ratchet member moves over the beaded chain.

10. The actuator system of claim 1 wherein the first ratchet member is forced into engagement with the beaded chain by a biasing member.

11. The actuator system of claim 1 wherein the first ratchet member is forced into engagement with the beaded chain by a magnetic biasing member.

12. The actuator system of claim 1 wherein the second ratchet member is forced into engagement with the beaded chain by a biasing member.

13. The actuator system of claim 1 wherein the second ratchet member is forced into engagement with the beaded chain by a magnetic biasing member.

14. An actuator system for facilitating movement of shade material of a window shade system between an open position and a closed position, the window shade system having a beaded chain, the actuator system comprising:
a cover;
wherein the beaded chain is at least partially positioned within the cover;
an actuator mechanism;
the actuator mechanism having a carrier;
the actuator mechanism having a first ratchet member;
the actuator mechanism having a second ratchet member;
wherein the first ratchet member is configured to engage a portion of the beaded chain;
wherein when the first ratchet member is engaged with a portion of the beaded chain and the carrier is moved downward, the first ratchet member moves the portion of the beaded chain downward thereby raising or lowering the shade material;
wherein the second ratchet member is configured to engage a portion of the beaded chain; and
wherein when the second ratchet member is engaged with a portion of the beaded chain and the carrier is moved downward, the second ratchet member moves the engaged portion of the beaded chain downward thereby raising or lowering the shade material.

15. The actuator system of claim 14 wherein when the first ratchet member is engaged with a portion of the beaded chain and the carrier is moved downward, the shade material is lowered.

16. The actuator system of claim 14 wherein when the second ratchet member is engaged with a portion of the beaded chain and the carrier is moved downward, the shade material is raised.

17. The actuator system of claim 14 wherein when the first ratchet member is engaged with a portion of the beaded chain and the carrier is moved upward, the first ratchet member moves over the beaded chain.

18. The actuator system of claim 14 wherein when the second ratchet member is engaged with a portion of the beaded chain and the carrier is moved upward, the second ratchet member moves over the beaded chain.

19. The actuator system of claim 14 wherein the first ratchet member or the second ratchet member is caused to engage a portion of the beaded chain by a selector.

20. The actuator system of claim 14 wherein when the first ratchet member engages the beaded chain, the beaded chain is pinched between a connection end of the first ratchet member and an interior surface of the carrier.

21. The actuator system of claim 14 wherein when the second ratchet member engages the beaded chain, the beaded chain is pinched between a connection end of the second ratchet member and an interior surface of the carrier.

22. The actuator system of claim 14 wherein when the first ratchet member is engaged with a portion of the beaded chain, the first ratchet member stays engaged with the beaded chain until the first ratchet member is disengaged from the beaded chain.

23. The actuator system of claim 14 wherein when the second ratchet member is engaged with a portion of the beaded chain, the second ratchet member stays engaged with the beaded chain until the second ratchet member is disengaged from the beaded chain.

24. The actuator system of claim 14 wherein the first ratchet member is forced into engagement with the beaded chain by a biasing member.

25. The actuator system of claim 14 wherein the first ratchet member is forced into engagement with the beaded chain by a magnetic biasing member.

26. The actuator system of claim 14 wherein the second ratchet member is forced into engagement with the beaded chain by a biasing member.

27. The actuator system of claim 14 wherein the second ratchet member is forced into engagement with the beaded chain by a magnetic biasing member.

28. An actuator system for facilitating movement of shade material of a window shade system between an open position and a closed position, the window shade system having a beaded chain, the actuator system comprising:
a cover;
wherein the beaded chain is at least partially positioned within the cover;
an actuator mechanism;
the actuator mechanism having a carrier;
the actuator mechanism having a first ratchet member;
the actuator mechanism having a second ratchet member;
the actuator mechanism having a selector;
wherein movement of the selector facilitates engagement of the first ratchet member with the beaded chain;
wherein the first ratchet member remains engaged with the beaded chain until the selector disengages the first ratchet member from the beaded chain;
wherein movement of the selector facilitates engagement of the second ratchet member with the beaded chain; and
wherein the second ratchet member remains engaged with the beaded chain until the selector disengages the second ratchet member from the beaded chain.

29. The actuator system of claim 28 wherein when the first ratchet member is engaged with the beaded chain and the carrier is moved downward, the first ratchet member moves the beaded chain downward, thereby raising or lowering the shade material.

30. The actuator system of claim 28 wherein when the first ratchet member is engaged with the beaded chain and the carrier is moved upward, the first ratchet member moves over the beaded chain.

31. The actuator system of claim 28 wherein when the second ratchet member is engaged with the beaded chain and the carrier is moved downward, the second ratchet member moves the beaded chain downward, thereby raising or lowering the shade material.

32. The actuator system of claim 28 wherein when the second ratchet member is engaged with the beaded chain and the carrier is moved upward, the second ratchet member moves over the beaded chain.

33. The actuator system of claim 28 wherein when the selector facilitates engagement of the first ratchet member the beaded chain, the beaded chain is pinched between a connection end of the first ratchet member and an interior surface of the carrier.

34. The actuator system of claim 28 wherein when the selector facilitates engagement of the second ratchet member with the beaded chain, the beaded chain is pinched between a connection end of the second ratchet member and an interior surface of the carrier.

35. The actuator system of claim 28 wherein the first ratchet member is forced into engagement with the beaded chain by a biasing member.

36. The actuator system of claim 28 wherein the first ratchet member is forced into engagement with the beaded chain by a magnetic biasing member.

37. The actuator system of claim 28 wherein the second ratchet member is forced into engagement with the beaded chain by a biasing member.

38. The actuator system of claim 28 wherein the second ratchet member is forced into engagement with the beaded chain by a magnetic biasing member.

39. An actuator system for facilitating movement of shade material of a window shade system between an open position and a closed position, the window shade system having a beaded chain, the actuator system comprising:
a cover;
wherein the beaded chain is at least partially positioned within the cover;
an actuator mechanism;
the actuator mechanism having a carrier;
the actuator mechanism having a first ratchet member;
the actuator mechanism having a second ratchet member;
wherein the first ratchet member is configured to be selectively engaged with a portion of the beaded chain and the second ratchet member is configured to be selectively engaged with a portion of the beaded chain;
wherein when one of the first ratchet member or the second ratchet member is engaged with a portion of the beaded chain and the carrier is moved downward, the first ratchet member or the second ratchet member moves the beaded chain downward thereby raising or lowering the shade material; and
wherein when one of the first ratchet member or the second ratchet member is engaged with a portion of the beaded chain and the carrier is moved upward, the first ratchet member or the second ratchet member moves over the beaded chain, thereby allowing a user to repeatedly raise and lower the carrier in order to raise or lower the shade material without having to repeatedly disengage and re-engage either of the first ratchet member or the second ratchet member with a portion of the beaded chain.

40. The actuator system of claim 39 wherein when the selector facilitates engagement of the first ratchet member with the beaded chain, the beaded chain is pinched between a connection end of the first ratchet member and an interior surface of the carrier.

41. The actuator system of claim 39 wherein when the selector facilitates engagement of the second ratchet member with the beaded chain, the beaded chain is pinched between a connection end of the second ratchet member and an interior surface of the carrier.

42. The actuator system of claim 39 wherein the first ratchet member or the second ratchet member is caused to engage a portion of the beaded chain by a selector.

43. The actuator system of claim 39 wherein when the first ratchet member is engaged with a portion of the beaded chain, the first ratchet member stays engaged with the beaded chain until the first ratchet member is disengaged from the beaded chain.

44. The actuator system of claim 39 wherein when the second ratchet member is engaged with a portion of the beaded chain, the second ratchet member stays engaged with the beaded chain until the second ratchet member is disengaged from the beaded chain.

45. The actuator system of claim 39 wherein the first ratchet member is forced into engagement with the beaded chain by a biasing member.

46. The actuator system of claim 39 wherein the first ratchet member is forced into engagement with the beaded chain by a magnetic biasing member.

47. The actuator system of claim 39 wherein the second ratchet member is forced into engagement with the beaded chain by a biasing member.

48. The actuator system of claim 39 wherein the second ratchet member is forced into engagement with the beaded chain by a magnetic biasing member.
